(19) United States
(12) Patent Application Publication
(10) Pub. No.: US 2017/0290318 A1
(43) Pub. Date: Oct. 12, 2017

(54) STAGING SURFACE FLYING INSECT TRAP

(71) Applicant: John Roderic Bergengren, Bradenton, FL (US)

(72) Inventor: John Roderic Bergengren, Bradenton, FL (US)

(21) Appl. No.: 15/484,103

(22) Filed: Apr. 10, 2017

Related U.S. Application Data
(60) Provisional application No. 62/320,610, filed on Apr. 10, 2016.

(51) Int. Cl. A01M 1/08; A01M 1/06; A01N 25/08; A01M 1/24; A01M 1/22; A01M 1/02; A01M 1/10

(52) U.S. Cl. CPC A01M 1/08; A01M 1/023; A01M 1/06; A01M 1/106; A01M 1/24; A01M 1/223; A01M 1/226; A01N 25/08

(57) ABSTRACT

Devices are embodied that eliminate flying insect pests in quite a different way than others devices have used in the past. If insects are attracted to a surface large enough to accommodate their numbers and allowed to gather for a time without being restrained or bothered, it is possible by way of these embodiments at a single location to eliminate insects in very large number on a daily basis. Depending on a device's size and embodiment, from several hundred to far in excess of one hundred thousand flying insects per twenty-four hour period can be eliminated.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—PRIOR ART

### A Listing of Prior Art

U.S Patents

| Patent Number | Kind Code | Issue Date | Patentee |
|---|---|---|---|
| 8,973,299 | B2 | Mar. 10, 2015 | Durand |
| 6,892,492 | B1 | May 17, 2005 | Durand |
| 6,840,005 | B1 | Jan. 11, 2005 | Durand |
| 6,817,140 | B1 | Nov. 16, 2004 | Durand |
| 8,810,411 | B2 | Aug. 19, 2014 | Marka |
| 8,139,858 | B1 | Mar. 20, 2012 | Landwehr |
| 7,916,951 | B2 | Mar. 29, 2011 | Landwehr |
| 7,496,228 | B2 | Feb. 24, 2009 | Landwehr |
| 8,109,035 | B2 | Feb. 7, 2012 | Bowden |
| 7,694,455 | B1 | Apr. 13, 2010 | Bowden |
| RE40,646 | B1 | Mar. 10, 2009 | Nelson |
| 6,568,123 | B1 | May 27, 2003 | Nelson |
| 6,467,215 | B1 | Oct. 22, 2002 | Nelson |
| 6,920,716 | B1 | Jul. 26, 2005 | Kollars |
| 6,134,826 | B1 | Oct. 24, 2000 | Mah |
| 5,806,238 | B1 | Sep. 15, 1998 | Brenner |
| 6,134,826 | B1 | Oct. 24, 2000 | Mah |
| 5,806,238 | B1 | Sep. 15, 1998 | Brenner |

U.S. Patent Application Publications

| Publication Num. | Kind Code | Publication Date | Applicant |
|---|---|---|---|
| US 20100037512 A1 | A1 | Feb. 18, 2010 | Durand |
| US 20120032096 A1 | A1 | Feb. 9, 2012 | Marka |
| US 20090153659 A1 | A1 | Jun. 18, 2009 | Landwehr |
| US 20050025357 A1 | A1 | Feb. 3, 2005 | Landwehr |
| US 20100229458 A1 | A1 | Sep. 16, 2010 | Bowden |

Foreign Patent Documents

| | | | |
|---|---|---|---|
| | Kind | Publication | |
| Foreign Doc. Num. | Code | date | Applicant or Patentee |

| | | |
|---|---|---|
| WO 97/10709 | March 1997 | W O Durand |
| WO 2005/082139 | September 2006 | W O Durand |
| W199 61 133 | December 1999 | D E Durand |
| 717903 | January 1932 | F R Durand |
| 1-14128 | April 1989 | J P Durand |
| 2-63679 | May 1990 | J P Durand |
| 3316045 | November 1984 | D E Bowden |
| 2852490 | September 2004 | F R Bowden |
| 2410668 | August 2005 | G B Bowden |
| 01273534 | November 1989 | J P Bowden |
| 10146145 | June 1998 | J P Bowden |
| 2003061541 | March 2003 | J P Bowden |
| 2003144031 | May 2003 | J P Bowden |
| 2005087199 | April 2005 | J P Bowden |
| 2006223276 | August 2006 | J P Bowden |
| 2007215469 | August 2007 | J P Bowden |
| 2007236359 | September 2007 | J P Bowden |
| 2008307037 | December 2008 | J P Bowden |
| WO 03007710 | January 2003 | W O Bowden |
| WO 2007032745 | March 2007 | W O Bowden |
| 601 978 | July 1978 | C H Nelson |
| 959 861 | March 1957 | D E Nelson |
| 28 11 532 | June 1977 | D E Nelson |
| 26 22 101 | December 1977 | D E Nelson |
| 2811532 | June 1979 | D E Nelson |
| 2003339292 | December 2003 | J P Nelson |
| 9944477 | March 2000 | A U Kollars |
| 4414796 | November 1995 | D E Kollars |
| 10108179 | December 2002 | D E Kollars |
| 2365746 | February 2002 | G B Kollars |
| 5-103571 | April 1993 | J P Kollars |
| 6-46 | January 1994 | J P Kollars |
| 7-203821 | August 1995 | J P Kollars |
| 8-56543 | March 1996 | J P Kollars |
| 8-154553 | June 1996 | J P Kollars |
| 10-229801 | September 1998 | J P Kollars |
| 2000-139318 | May 2000 | J P Kollars |
| 2003-61541 | March 2003 | J P Kollars |
| WO-89/12389 | December 1989 | W O Kollars |
| WO-92/17060 | October 1992 | W O Kollars |
| WO-95/29584 | November 1995 | W O Kollars |
| WO-99/26471 | June 1999 | W O Kollars |

### Nonpatent Literature Documents

### DURAND:

Grant et al., “Electrophysiological responses of receptor neurons in mosquito maxillary palp sensilla to carbon dioxide,” J. Comp Physiol A, p. 389-396, (1995).
Sudia and Chamerlain, “Journal of the American Mosquito Control Association,” p. 536-538, (1988).
Peterson and Brown, “Studies of the responses of the female Aedes Mosquito. Part III The response of the Aedes Aegypti (L.) to a warm body and its radiation,” Biting Insect Technology, p. 535-541, (1951).
Carestia and Savage, “Effectiveness of carbon dioxide as a mosquito attractant in the CDD miniature light trap,” J. American Mosquito Control Assn, vol. 27 (No. 1), p. 90-92, (March 1967).
Service, “Sampling adjults by animal bait catches and by animal-baited traps,” Mosquito Ecology Field Sampling Methods, 2nd ed., p. ch. 5, 349-498, (1995).
Service, “Sampling adults by carbon dioxide traps, light traps, visual attraction traps and sound traps,” Mosquito Ecology Field Sampling Methods, 2nd ed., p. ch 6., 499-610, (1995).
Floore et. al., “Mosquito trapping studies to determine the efficacy of two models of the Flowtron(R) mosquito luring device,” J. Florida Anti-mosquito Assn., vol. 56 (No. 1), p. 13-17, (1985).
“Dipterian Collection Equipment Folder,” American Biophysics Corporation.
“Owner's Manual, BugVac (tm) Model 1101 Electronic Insect Killer”.
Kline, “Comparison of two American biophysics mosquito traps: the Professional and a new counterflow geometry trap,” J. American Mosquito Control Assg, vol. 15 (No. 3), p. 276-282, (1999).
Kline, “Comparison of two American biophysics mosquito traps: the professional and a new counterflow geometry trap,” J. American Mosquito Control Assg, vol. 15 (No. 3), p. 276-282.
Butkett et al., “Light, carbon dioxide and octenol-baited mosquito trap and host-seeking activity evaluations for mosquitos in a malarious area of the Republic of Korea,” J. American Mosquito Control Assn, vol. 17 (No. 3), p. 196-205.
“Mosquito Ecology Field Sampling Methods,” 2nd ed., p. 500, 502, 517, 524 and 546-547.
“Mosquito News,” vol. 27 (No. 1), p. 90-92.
Mboera et al., “Comparison of carbon dioxide-baited trapping systems for sampling outdoor mosquito populations in Tanzania,” Med. & Vet. Entomology, 14, 2000, p. 257-263.
“Catalytic Burner Litearature,” Teledyne Brown Systems, January 1997. Teledyne Brown Systems, Catalytic Burner literature, 90/006,156, November 2001, Wigton et al.

### MARKA:

ISA, “International Search Report and Written Opinion regarding PCT/US2010/031437”, Jun. 15, 2010, pp. 4-9, Publisher: WIPO. cited by applicant.

### LANDWEHR:

Adlerz, W. C., “Comparison of Aphids Trapped on Vertical Sticky Board and Cylindrical Aphid Traps and Correlation with Watermelon Mosaic”, “Journal of Economic Entomology”, August 1976, pp. 495-498, vol. 69, No. 4. cited by other .
Agudelo-Silva, Fernando, et al., “Dormant Season Application of Steinernema carpocapsae (Rhabditida: Steinernematidae) and Heterorhabditis Sp. (Rhabditida”, “Florida Entomologist”, September 1995, pp. 516-523, vol. 78, No. 3. cited by other.
Atmar, J. W., et al., “Construction of a Device to Identify and Count Insects Automatically”, “Environmental Entomology”, August 1973, pp. 713-716, vol. 2, No. 4. cited by other.
Ballard, Dana H., et al., “Computer Vision”, “Table of Contents, 151-152, 235-127, Author Index,Subject Index”, 1982, Publisher: Prentice-Hall, Inc.: Englewood Cliffs, N.J. cited by other.
Barnett, Vic, et al., “Outliers in Statistical Data (Second Edition)”, “Table of Contents, 144-202, 243-280, Index”, 1978, Publisher: John Wiley & Sons Ltd.: Chichester. cited by other.
Bergman, D. K., et al., “Cuticular Hydrocarbons of the Russian Wheat Aphid”, “Southwestern Entomologist”, June 1990, pp. 91-100, vol. 15, No. 2. cited by other.
Berlinger, M. J., “A Yellow Sticky Trap for Whiteflies: Trialeurodes vaporariorum and Bemisia tabaci (Aleurodidae)”, “Ent. Exp. & Appl.”, 1980, pp. 98-102, vol. 27. cited by other.
Booth, Steven R., et al., “Evaluation of Entomopathogenic Nematodes to Manage Root Weevil Larvae in Washington State Cranberry, Strawberry, and Red”, “Environmental Entomology”, 2002, vol. 31, No. 5. cited by other.
Chai, Douglas, et al., “A Bayesian Approach to Skin Color Classification in YCBCR Color Space”, “IEEE Region Ten Conference (TENCO 2000), Kuala Lumpur, Malaysia, 2”, September 2000, pp. 421-424, vol. II. cited by other.
Clark, J. D., et al., “A Battery-Powered Light Trap Giving Two Years' Continuous Operation”, “Journal of Economic Entomology”, April 1973, pp. 393-396, vol. 66, No. 2. cited by other.
Di Ruberto, Cecilia, et al., “Analysis of Infected Blood Cell Images Using Morphological Operators”, “Image and Vision Computing”, February 1, 2002, pp. 133-146, vol. 20, No. 2. cited by other.
Dietrich, Christopher H., et al., “Automated Identification of Leafhoppers (Homoptera: Cicadellidae: Draeculacephala Ball)”, July 1994, pp. 412-423, vol. 87, No. 4, Publisher: Annals of the Entomological Society of America. cited by other.
Estep, Kenneth W., et al., “Counting, Sizing, and Identification of Algae Using Image Analysis”, “Sarsia”, December 29, 1989, pp. 261-268, vol. 74. cited by other.
PIC Corporation (Company), “Jumbo Fly Stick”, “web address: http://web.archive.org/web/20030413160103/www.pic-corp.com/www/consumer/flystik.html”, Jun. 1, 2002. cited by other.
Hart, Peter E., “The Condensed Nearest Neighbor Rule”, “IEEE Transactions on Information Theory”, May 1968, pp. 515-516. cited by other.
Herms, W. B., “A Field Test of the Effect of Artificial Light on the Behavior of the Codling Moth”, “Journal of Economic Entomology”, Feb. 1929, pp. 78-88, vol. 252. cited by other.
Hienton, Truman E., “Summary of Investigations of Electric Insect Traps”, “Technical Bulletin No. 1498, Agricultural Research Service, United States Department of Agriculture: Washington, D.C.”, October 1974. cited by other.
Kerguelen, V., et al., “Measuring Mite Feeding Damage on Avocado Leaves With Automated Image Analysis Software”, “Florida Entomologist”, March 1999, pp. 119-122, vol. 82, No. 1. cited by other.
Kim, Soowon, et al., “Detection of Insect Damage in Almonds”, “Proc. SPIE—Precision Agriculture and Biological Quality, George E. Meyer; James A. Deshazer; Eds.”, 1999, pp. 101-110, vol. 3543. cited by other.
Kokko, E.G., et al., “Method to Quantify Leaf Beetle Consumption of Leaf Disks Using Image Analysis”, “The Canadian Entomologist”, July/August 1995, pp. 519-525, vol. 127. cited by other.
Lockey, Kenneth H., “Lipids of the Insect Cuticle: Origin, Composition and Function”, “Comp. Biochem. Physiol”, 1988, vol. 89B, No. 4. cited by other.
Lopez-D., Fernando, et al., “A New Yeast Hydrolysate-Borax Bait for Trapping the Caribbean Fruit Fly”, “Journal of Economic Entomology”, December 1971, pp. 1541-1543, vol. 64, No. 6. cited by other.
Moffitt, H. R., “A Color Preference of the Western Flower Thrips, Frankliniella Occidentalis”, “Journal of Economic Entomology”, August 1964, vol. 57, No. 4. cited by other.
Motulsky, Harvey , “Detecting Outliers”, “GraphPad.com http://www.graphpad.com/articles/outlier.htm”, 1995-2002, pp. 1-4. cited by other.
Ong, S. H., et al., “Segmentation of Color Images Using a Two-Stage Self-Organizing Network”, “Image and Vision Computing”, Apr. 1, 2002, pp. 279-289, vol. 20, No. 4. cited by other.
Petitt, F. L., et al., “An Automated System for Collection and Counting of Parasitized Leafminer (Diptera agromyzidae) Larvae”, “Florida Entomologist”, September 1996, pp. 450-454, vol. 79, No. 3. cited by other.
Riley, D.G., et al., “Pepper Weevil Adult Response to Colored Sticky Traps in Pepper Fields”, “Southwestern Entomologist”, June 1994, pp. 93-107, vol. 19, No. 2. cited by other.
Russ, John C., “The Image Processing Handbook (2nd Edition)”, “Table of Contents, 199-201, 523-526, Index”, 1995, Publisher: CRC Press, Inc.: Boca Raton. cited by other.
Shuman, D., et al., “A Computer-Based Electronic Fall-Through Probe Insect Counter for Monitoring Infestation in Stored Products”, “Transactions of the ASAE”, 1996, pp. 1773-1780, vol. 39, No. 5. cited by other.
Smith, Kirk A., “Control of Insect Pests With Entomopathogenic Nematodes”, “http://www.agnet.org/library/article/tb139a.html”, Oct. 1, 1994, pp. 1-9, Publisher: Food & Fertilizer Technology Center. cited by other.
Spielman, Andrew, “Reducing Dengue Disease Using Biological Agents”, “http://www.solutions—site.org/kids/stories/KScat4.sub.—so178.sub.—2.ht-m”, Unknown, Publisher: Horizon Solutions Site for Kids, (2003). cited by other.
Tou, Julius T., et al., “Pattern Recognition Principles”, “Table of Contents, 81-86, 316-361, Index”, 1974, Publisher: Addison-Wesley Publishing Company, Inc.: Reading, Mass. cited by other.
Tumlinson, J. H., et al., “Sex Pheromones Produced by Male Boll Weevil: Isolation, Identification, and Synthesis”, “Science”, Nov. 21, 1969, pp. 1010-1012, vol. 166. cited by other
Van De Vooren, J. G., et al., “Identification of Mushroom Cultivars Using Image Analysis”, “Transactions of the Asae”, January-February 1992, pp. 347-350, vol. 35, No. 1. cited by other.
Vernon, R. S., et al. , “Spectral Responsiveness of Frankliniella occidentalis (Thysanoptera:Thripidae) Determined by Tarp Catches in Greenhouses”, “Environmental Entomology”, October 1990, pp. 1229-1241, vol. 19, No. 5. cited by other.
Weeks, P. J. D., et al., “Automating Insect Identification: Exploring the Limitations of a Prototype System ”, “J. Appl. Ent. ”, 1999, pp. 1-8, vol. 123. cited by other.
Weeks, P. J. D., et al., “Automating the Identification of Insects: A New Solution to an Old Problem”, “Bulletin of Entomological Research”, 1997, vol. 87. cited by other.
Weeks, Arthur R., “Fundamentals of Electronic Image Processing.”, 1996, Page(s) Table of Contents, 2, Publisher: SPIE Optical Engineering Press: Bellingham. cited by other.
Weeks, P. J. D., et al., “Species-Identification of Wasps Using Principal Component Associative Memories”, “Image and Vision Computing”, October 1999, pp. 861-866, vol. 17, No. 12. cited by other.
Wingfield, Nick , “Cameras That Cater to Worrywarts Help Keep an Eye on Things”, Oct. 31, 2002, pp. B1, Publisher: The Wall Street Journal. cited by other.
Yu, Dicky S., et al., “Identification of Ichneumonid Wasps Using Image Analysis of Wings”, “Systematic Entomology”, 1992, pp. 389-395, vol. 17. cited by other.
Zayas, I. Y., et al., “Detection of Insects in Bulk Wheat Samples With Machine Vision”, “Transactions of the ASAE”, 1998, pp. 883-888, vol. 41, No. 3. cited by other.
Zhou, Yuan-Hua, et al., “Automatic Description of the Venation of Mosquito Wings From Digitized Images”, “Systematic Zoology”, 1985, pp. 346-358, vol. 34, No. 3. cited by other.
Sheets). cited by examiner.

### BRENNER:

Hedges, Stoy, “Entomo-LOGICAI Solutions”, PCT Magazine, July 1995.
Cohen, S. “A Collection and Marking System Suitable for Epidemiological Studies on Whitefly-Borne Viruses”, Plant Disease, vol. 73(9), pp. 765-768 (September 1989).
Sauflex, G., “A Rapid Method of Collecting Lipidopterous Larvae”, J. Econ. Ent., vo. 66(3), pp. 818-819 (June 1973).
Hedges, S. “IPM-21st Century Pest Management”, IN People Needing People, 1995 Convention Workbook, 62nd Annual Convention and Exposition (October 1995).
Clinch, P. “A Battery-operated Vacuum Device for Collecting Insects Unharmed”, New Zealand Entomologist, vol. 5(1), pp. 28-30 (1971).

### NELSON:

International Search Report for International Patent Application No. PCT/US01/16170, Mar. 5, 2002 (7

### DISCUSSING PRIOR ART GENERALLY

Mosquitoes are known to be pests and worse. They spread malaria, dengue fever, encephalitis, West Nile disease, Chikungunya and the Zika virus. Over a million people worldwide die from malaria each year, and countless others suffer recurring consequences from contracting that disease, though their lives are spared. Dengue fever has a hemorrhagic strain that causes cellular collapse and bleeding, similar to the Ebola virus. Encephalitis is devastative, as is West Nile. Chikungunya, also propagated by mosquitoes, is burning its way through the Caribbean and has been reported in the United States. As of September, 2014 half a million cases of Chikungunya had occurred in the Dominican Republic alone. And now the Zika virus is in the news, with the disease ravaging South and Central America. It is being transmitted primarily by the Aedes Aegypti mosquito which is a common type among our southern border states.

Several approaches exist for killing mosquitoes. Beyond spraying toxins generally and introducing oils or other surface water chemicals to lakes and stagnant waters to prevent breeding and kill larvae, there are devices that are sold to consumers.

Perhaps the oldest type of device is based on the concept of flypaper, a sticky substance coating a paper or other substrate, that will cause an attracted mosquito to become ensnared in a glue, unable to free itself. Several current commercial mosquito devices employ this idea, typically in conjunction with attractants such as light, soundwaves or gaseous compounds such as carbon dioxide (CO2), octanols (8-carbon alcohols) or other compounds.

One other type of mosquito device is commonly called a “Bug Zapper”, an electrically charged array of conductors held by a structure, so that mosquitoes and other insects become electrocuted as they bridge a pair of conductors. These often use an attractant to lure the insects to the device. Typically a light, often fluorescent and producing a certain percentage of its light in the ultra-violet range, is employed as the attractant, as are chemical compounds. This type of device has been on the market for decades.

Other types, of more recent origin, use a carbon dioxide generating system to lure mosquitoes to a vacuum orifice where they will be sucked in and trapped in a container, possibly electrocuted or disposed of in some other way.

Light waves, sound waves, carbon dioxide (CO2), octanol (1-octen-3-ol), nonanal (nonanaldehyde), sulcatone (6-methyl-5-hepten-2-one), and other chemical attractants have been used to attract mosquitoes in the many devices that have come to market. Each of these devices work. But “work” here is a relative term. Some are more effective than others, yet they all seem to suffer from a major drawback. They don't quickly eliminate mosquitoes in large numbers. And too, they are not easily scalable to huge proportion. The embodiments of the present invention can be designed to efficiently eliminate large numbers of flying insects, and they can be scaled up to large size for even greater effect.

The present author's embodiments solve problems involved with the elimination of flying insect pests in large numbers, from household to community levels. They utilize a novel approach in doing so. The embodiments, on a mosquito-for-mosquito basis are much less expensive than current approaches, and the embodiments are environmentally safe and pose no danger from fire or explosion.

### DISCUSSING THE PATENTS LISTED AS PRIOR SPECIFICALLY

Four patents issued to Durand et al: U.S. Pat. No. 8,973,299 (March 2015)—U.S. Pat. No. 6,892,492 (May 2005)—U.S. Pat. No. 6,840,005 (January 2005) and U.S. Pat. No. 6,817,140 (November 2004) concern the use of a combustible fuel burned to produce carbon dioxide which is then released into the outside environment as an attractant. The individual insects, upon arrival at the entrance of an inlet, are immediately sucked in to a confinement chamber. In at least one of these four patents a photo sensor is integral for detecting ambient light. Also claimed are an optical sensor, an imaging device for monitoring the accumulation of insects and a weather monitoring device.

The Durand patents involve a combustible fuel and the complicated and expensive hardware necessary for its use in the production of carbon dioxide. The system is bulky and heavy. The patents also call for monitoring devices, either to control the automatic production of CO2 at the mosquitoes' feeding times or control it according to the weather. The mosquito population is also electronically monitored, further adding to the expense. And too, the fuel tanks present a fire and explosion danger, and must be refilled periodically.

Another patent, one issued to Marka et al: U.S. Pat. No. 8,810,411 (August 2014) involves creating an optical barrier to deter the crossing of mosquitoes beyond the barrier's position in space. The optically generated barrier, though not a material object, can be configured to serve as a temporary confinement vessel. The barrier, in whichever form, is claimed as a deterrent to the freedom of movement of mosquitoes, not an attractant. The technology is advanced, and with the use of lasers and their automatic controllers, expensive. Though interesting in its technology approach, demonstrating ingenuity, the Marka patent doesn't easily allow for scalability to public venue size.

Three patents issued to Landwehr et al: U.S. Pat. No. 8,139,858 (March 2012)—U.S. Pat. No. 7,916,951 (March 2011) and U.S. Pat. No. 7,496,228 (February 2009) utilize a substrate or a sticky surface, and a camera, computer, histogram and internet combination to collect and categorize insect types. The substrate is not a staging surface for large numbers of insects and the system is not one for insect pest elimination.

The two patents issued to Bowden et al: U.S. Pat. No. 8,109,035 (February 2012) and U.S. Pat. No. 7,694,455 (April 2010) are for sequestration devices that allow the female mosquito to lay her eggs in a container of water by placing them through small holes in a platform which floats on the water. The platform's holes are of sufficient size for the pregnant female to access the water for egg-laying, but not for her offspring to vacate out through the platform after becoming adults, thus trapping the adult mosquitoes.

This device, though simple and inexpensive, is not readily scalable to very large sizes. And too, its operation is predicated on the female laying her eggs, which occurs after her blood meal. The present author's embodiments kill female mosquitoes that are in search of their blood meal, before they have taken blood from a human or an animal, possibly injecting a virus. And the present embodiments can kill the females in very large numbers per 24 hour period.

Three patents issued to Nelson et al: RE 40,646 (March 2009) . . . U.S. Pat. No. 6,568,123 (May 2003) and U.S. Pat. No. 6,467,215 (October 2002) are based on a digital signal processor, a digital to analog converter, an integrated circuit or an electronic memory, and a speaker, which together produce an attractive sound transmitted as vibrations to a resonator. The patents also provide for the use of heat and light as attractants. The resonator can be attached to or placed near a tube that has negative internal air pressure to draw insects through an inlet. A related method of attraction is that of a central sound generating device that propagates sound waves through hollow tubes leading to remote stations, at which the attracted mosquitoes are dispositioned. The Nelson devices can use a toxic or gluey substance applied to them or nearby, or other methods of controlling insect pests.

These patents don't provide a staging area where flying insects can congregate unmolestedly, and by this, form an attraction and increase their numbers until a disposition occurs. And they don't readily allow scalability to very large size and high efficiency.

A patent to Kollars, et al: U.S. Pat. No. 6,920,716 (July 2005) describes methods of attracting insect pests that involve the mixing over time of two or more chemical substances to produce carbon dioxide. This necessitates a technically involved operation, and probably an expensive one. Adhesive and unspecified trapping means are stated as methods of disposition once insects are attracted to the device.

The patent to Mah: U.S. Pat. No. 6,134,826 (October 2000) discloses a device that has an attractant light source suspended within an open upper chamber and also contains an electrical device for disabling and disorienting insects that enter the chamber and proceed to the electrically disabling device. It operates by disabling, dehydrating and killing flying insects, ostensibly one at a time, while the present author's embodiments dispose the insects by the hundreds and thousands at a time, and more, depending on scale.

The patent to Brenner et al: U.S. Pat. No. 5,806,238 (September 1998) is for a hand-held device that utilizes a variable suction intake function in conjunction with an air filter to remove foul exhaust odor. It is useful for manually going after insects that are located in particular places, such as the interior of waste tires, or other tight places soon after the mosquitoes' emergence from water. It won't however attract flying insects from distances, nor dispose them in great numbers. It doesn't work automatically, independent of human control like the present embodiments, is not scalable to large size, and it doesn't eliminate the females per se, which the present embodiments do, making them more efficient at terminating future generations of flying insects before they occur.

The above patents carry with them a common deficiency, one that exists throughout the field of flying insect control: The devices are not able to efficiently terminate insect pests in large number. They operate by seemingly attracting and terminating flying insect pests one at a time. Except for spraying toxics over large areas, or substances upon bodies of water, both of which are methods, not devices, and environmentally destabilizing, there are no available ways to automatically terminate large numbers of mosquitoes on a daily basis.

Further, the devices above exhibit the necessity of expense, of complicated technology, of dealing with bulkiness, and of storage and use that is safe from fire and explosion.

The field of insect eradication has been found by the present author to be in need of a novel approach. The present embodiments accomplish this task.

### BACKGROUND—GENESIS OF THE PRESENT EMBODIMENTS

Having lived in Minnesota, I have been offered ample opportunity for acquaintance with mosquitoes. I have been had for lunch more than once. I have seen mosquitoes so thickly gathered in the air that their swirling plumes were visible from a half mile away. How many mosquitoes would you say are necessary to form a whirling conclave that is clearly visible from a half mile? Wouldn't it be in the high thousands?

The present embodiments grew from summertime observations. I would look out over the rear deck of our house and be struck by the number of mosquitoes that were staging at or hovering very near the lighted eave . . . the soffit underneath a roof's extension, typically paneled. There were thousands. Night after night I turned on a light aimed at the eave and they would soon come, largely disappearing when the light was turned off. I tried counting, but accuracy was difficult. Taking scaled best guesses I figured there were as many as 5,000. And this number at just one house!

After some nights had passed, observing the same thing, I went out on the deck with a canister type vacuum cleaner and stood there vacuuming them off of the eave for a while. They didn't seem to mind. They stirred only slightly as the vacuum, with all of its noise, continued to whittle down their numbers. I quit vacuuming after a while that night, wanting to see if mosquitoes would keep on visiting the eave every night in large numbers. They did. And every summer it's been the same kind of congregating.

### BACKGROUND OF THE INVENTION—OBJECTS AND ADVANTAGES

With Zika currently terrorizing much of South and Central America, and having reached to the Caribbean before the major part of the 2016 mosquito season is here, people are justifiably alarmed. And it's only a matter of time . . . perhaps this mosquito season . . . until the virus plagues the mainland United States, especially along our southern states of Florida, Alabama, Louisiana and Texas. Their neighbors to the immediate north, are in for a rough time should Zika be vectored there. And it would probably happen. The western world isn't alone in this. Southeast Asia is suffering from Zika, as is Africa. And there are malaria (which kills one million people a year), West Nile, Chicungunya, encephalitis, dengue fever and other illnesses vectored by mosquitoes.

It is a major object of the present embodiments to overcome the lack of ability of prior devices to eliminate large numbers of mosquitoes (and/or other flying insect pests) quickly and inexpensively.

Within this it is a further object to provide a type of anti-mosquito/anti-flying insect pest device that is a highly effective portable device for consumers in the yard or on the deck at home, at the cabin, even on picnics . . . yet the general concept of which can be extended to the manufacture of large structures, enabling the attraction and elimination of mosquitoes in the range of hundreds of thousands per 24 hour period. This latter would prove very useful for public parks, sports stadiums, golf courses, schools or other public venues, even whole villages. As to scalability, it is feasible to produce the present embodiments extending from tabletop devices to those many feet tall or hundreds of feet long.

The present embodiments can accomplish these objectives. They are capable of eliminating huge numbers of mosquitoes in a single 24 hour period, and when used throughout a mosquito season, consisting of several waves of newly hatched mosquitoes, the embodiments can severely dampen a local mosquito population by way of eliminating large numbers of females searching for blood meals from humans or animals, needed in order to provide future generations of mosquitoes. This leads directly to the objectives of both a more enjoyable current outdoor season and the steadily increasing benefit of succeeding seasons that are more mosquito-free.

And the lessening of a third world locality's mosquito population will have direct benefit to public health, impacting positively the life and resilience of communities, which are also objects of the embodiments.

The advantages of such embodiments over the prior art are easily noticeable. For one, there is a lack in the prior art of scalability. The present embodiments are extremely scalable, from tabletop to village size. The field of current devices is designed to eliminate flying insect pests little more than one at a time, no matter the attractant used. The present embodiments can eliminate flying insect pests by the many thousands and more at a time, depending on scale, and repeat that several times per day in the same location.

Many current devices, such as those that produce carbon dioxide to attract mosquitoes to an orifice at the device where there is negative air pressure, and on to further disposition, are bulky and technically complicated and expensive to produce. Plus with them, there is the danger of fire and explosion involved with the need of using combustible fuel stored in tanks to produce the CO2, and the tanks must be refilled periodically. And of course, CO2 has a bad name among environmentalists, so that many may not purchase that kind of mosquito device, perhaps not using anything to eliminate mosquitoes.

More than the safety and complexity advantages the present embodiments offer over gaseous, combustible fuel CO2 devices, the technology of the present embodiments is much simpler, more failure-proof and less expensive, especially since there is no danger of explosion or fire to be accounted for in either the design or manufacture. And fuel doesn't need to be replenished periodically. Too, a combustible fuel device cannot be safely used indoors, while the present embodiments can, with appropriate scaling, be quite easily and effectively used in houses, supermarkets, schools, factories and other buildings.

Further, the present embodiments offer the ability to attract and kill mosquitoes without the need of sticky or toxic substances, or of causing fried carcasses and their smells, or the need to clean burned remains from an electric grid work. Chemicals don't have to be mixed, either manually or automatically.

### SUMMARY AND ADVANTAGES

The present embodiments are quite different in operating principle from the prior art. And they have several advantages over prior art. 1) One or more of the embodiments are usable at scales suitable for an individual household up to a village. 2) One or more of the embodiments, or their derivatives, can be fastened together like a chain or a railroad track, either substantially horizontally or vertically. 3) One or more of the embodiments are less expensive to implement in terms of design and manufacture than prior art that uses an overall modern, technical approach. 4) The embodiments are environmentally friendly, not involving the production of CO2 (carbon dioxide). 5) The embodiments are safer since they don't require the mixing of chemicals, or any chemicals at all. 6) They don't leave a burned, smelly residue as electrification of insects does. 7) The embodiments are safer as to fire and explosion since no combustible gas or liquid is involved, as with the production of CO2 in a series of popular prior art devices. 8) The present embodiments are more effective. They will attract more flying insects than the prior art because the embodiments provide an surface area for the insects to gather to, remaining unmolested until a per-determined time of disposition. During this time of staging the insects themselves act as attractants for other insects. If you can attract them and keep them there, you can eradicate them in large numbers. The present embodiments do that.

### DRAWINGS—FIGURES

FIG. 1 shows a vacuum wand system of one embodiment installed on a store wall for sweeping flying insects from a pre-existing staging surface that transmits light from pre-existing sources.

FIG. 2A is of the vacuum generation and insect trapping functions of FIG. 1. FIG. 2B shows a valve to keep the insects contained once trapped.

FIGS. 3A and 3C are of the drive components at the lower end of the wand of FIG. 1. FIGS. 3B and 3D depict the guiding components at the upper end of the wand.

FIGS. 4A and 4B concern an embodiment that is a large scale upright staging surface for public venues, with a vertically traveling vacuum wand and collector assembly.

FIGS. 5A and 5B show the drive mechanism for the public venue device of FIGS. 4A and 4B.

FIGS. 6A, 6B and 6C are of the vacuum components of FIGS. 4A and 4B.

FIG. 7 is an embodiment of a table-mounted light emitting insect trap that produces light by way of a modern technology found in entertainment devices or flat panel advertising or lighting.

FIGS. 8A, 8B and 8C depict a solar cell power source for the light emitting device of FIG. 7 and also the drive and vacuum systems.

FIGS. 9A, 9B and 9C are of a soffit-mounted vacuum trap embodiment that utilizes reflected light as an attractant.

FIGS. 10A and 10B show side and front views of the soffit-mounted embodiment.

FIGS. 11 and 12 are of an embodiment related to the soffit-mounted device of FIGS. 9 and 10, yet for use at a flexible staging surface rather than a soffit.

FIG. 13A depicts the embodiment of FIGS. 11 and 12 in use at a flexible staging surface that is oriented substantially horizontally. FIG. 13B is a vertically oriented embodiment of FIGS. 11 and 12 with the trap having an approximate right angle bend to allow less torque by the embodiment against the vertically oriented staging surface, which runs up the side of a building.

FIG. 14 is an embodiment of a portable insect trap that has multiple transparent rotating staging surfaces and stationary vacuum inlets that, in conjunction with the rotating surfaces, bring about the vacuum sweeping of both the top and bottom of each rotating staging surface.

FIG. 15 shows the drive and rotational support mechanisms of the embodiment of FIG. 14 and gives a cursory look at its vacuum system.

FIGS. 16 and 17 are detailed views of the vacuum system of the embodiment of FIGS. 14 and 15.

DRAWINGS - Reference Numerals

```
  50 Flying insect(s)
  52 Exterior wall
  54 Pre-existing light source
  56 Roof
  58 Soffit
100 Storefront staging surface
110 Collector assembly
112 Collector assembly housing
113 Access door
114 Fan motor and blades
116 Fan support vanes
118 Protective grill
120 Collector
121 Collector valve assembly
122 Collector valve flap
123 Collector valve spring
124 Valve spring form
125 Valve frame
126 Funnel tube
128 Air funnel
130 Vacuum wand
132 Air intake slots
134 Incoming air
136 Outgoing air
140 Drive motor/helical pinion gear unit
142 Lower carriage assembly
144 Carriage front
146 Carriage wheel
150 Lower track
152 Linear helical gear rack
154 Helical pinion gear
160 Upper carriage assembly
170 Upper track
200 Public venue staging surface
210 Bifurcated vacuum wand
212 Wand mounting plate
220 Screw shaft
222 Screw shaft key slot
230 Wand drive assembly
232 Drive motor/gear reduction unit
233 Motor straps
234 Splined shaft
235 Motor mounting plate
236 Screw shaft gear
237 Internal threads
238 Screw shaft keys
239 Sliding collar
240 Upper pole
242 Pole sleeve
244 Pole stop
245 Sleeve bearings
246 Support bearing
248 Lower pole
250 Lower frame
252 Lower screw shaft support
260 Upper fra261 Upper pole frame support
262 Upper screw shaft support
270 Impinging light source
272 Non-impinging light source
290 Air intake ports
292 Air channeling wall
300 Flat panel staging surface
302 Table top
304 Solar panel
306 Table vacuum carriage
308 Air intake slot
310 Drive motor/gear reduction unit
312 Drive differential
314 Worm drive shaft
320 Axle
322 Wheel(s)
323 Axle bearing
324 Carriage support channel
400 Soffit staging surface
410 Non-integral light source
411 Electrical leads
412 Integral light source
419 Axle slot
420 Soffit vacuum carriage
421 Soffit carriage support channel
422 Channeling box
423 Soffit vacuum carriage top
424 Air intake bridging
425 Drive motor/gear reduction unit
426 Motor mount
428 Drive belt
429 Driven axle
430 Soffit collector canister
432 Canister access door
500 Flexible staging surface
502 Traction wheel
504 Side plate axle bearing
506 Clamping wheel
508 Clamping lever
510 Clamping lever pivot
512 Clamping lever spring
514 Side plate
516 Flexible staging surface assembly
517 Modified flexible staging surface assembly
600 Transparrent rotatable staging surface
601 Transparent rotatable staging surface assembly
602 Transparent support column
604 Vacuum inlet
606 Vacuum tube
608 Light source
610 Upper rotation assembly
612 Protective cover
614 Upper ball bearing
616 Upper mounting plate
620 Lower rotation assembly
621 Lower ball bearing
622 Lower mounting place
630 Drive motor/gear reduction unit
632 Drive gear
634 Driven gear
636 Controller
640 Air flow
```

### DETAILED DESCRIPTION—THE SEVERAL EMBODIMENTS

No embodiment among those described is to be considered preferred. They each have a place in the market, and by adjusting their design size, can overlap another's typical use.

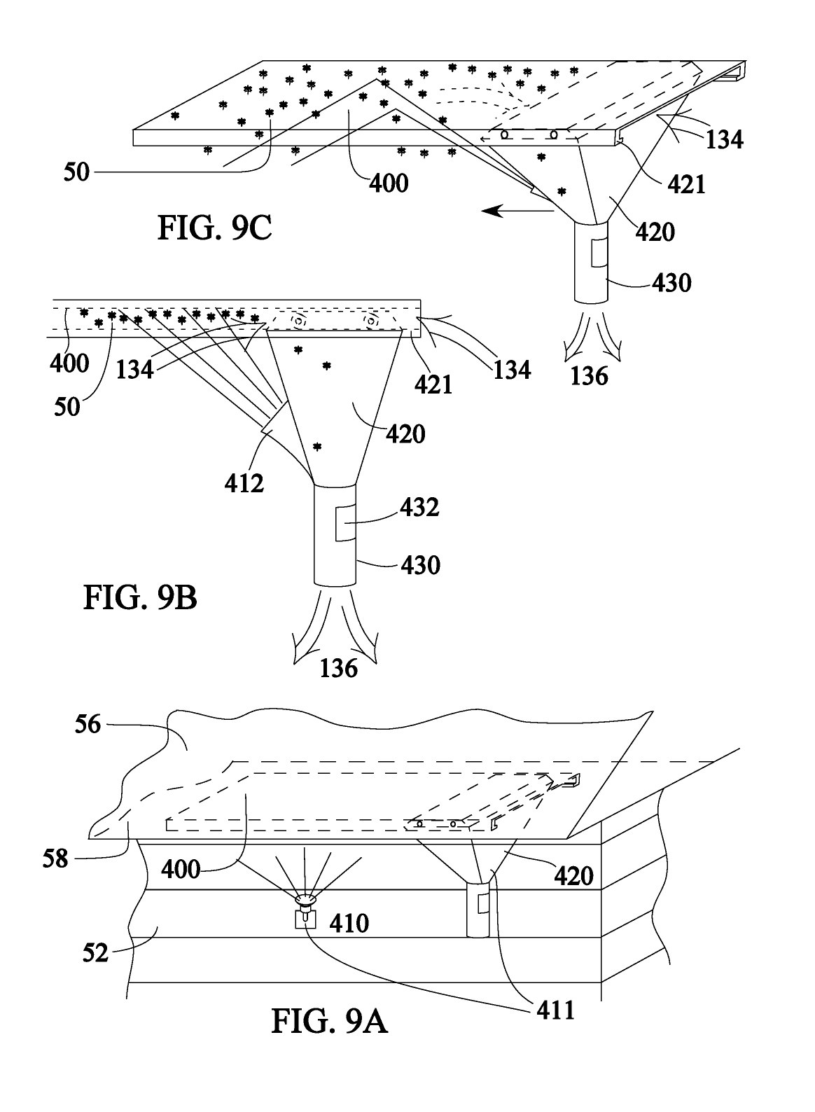

Except for FIGS. 9A, 14 and 15 no electrical connections or controls are depicted. It is assumed by the author that practices well known in the art will have been followed in providing connections and controls during a design phase. Timing and movement limitation devices and applications, for instance 555 timer circuits and micro-switches are contemplated by the author, though other methods are not excluded.

### Operation of the First Embodiment

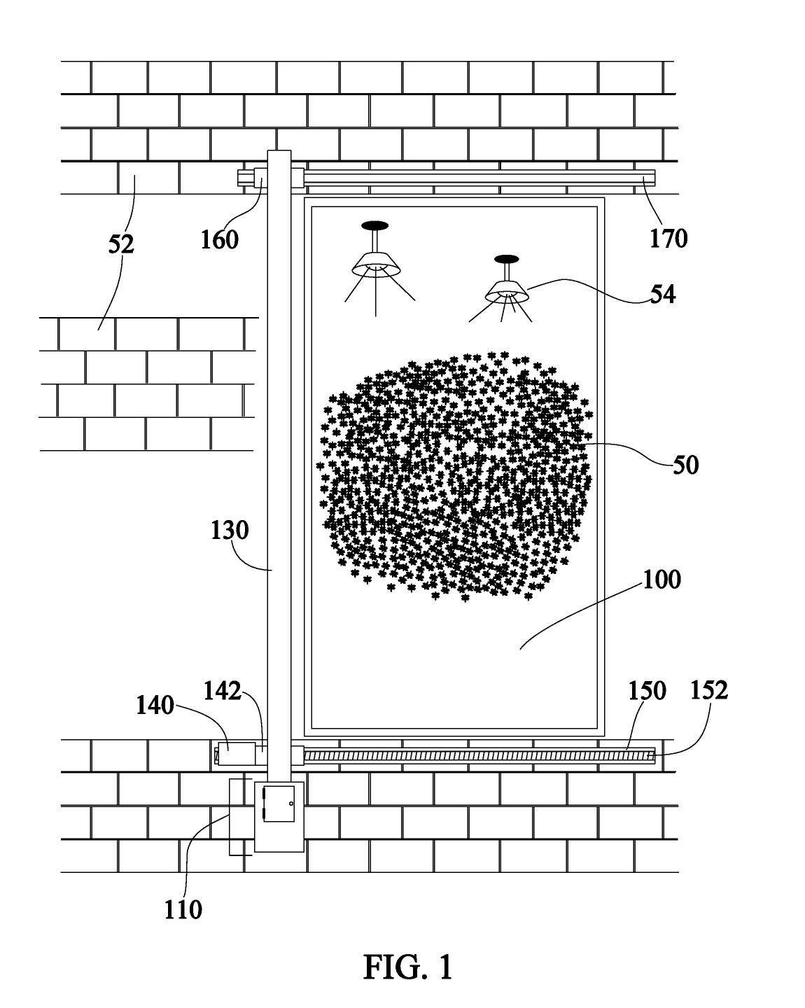

A first embodiment, FIGS. 1-3, uses a staging surface (a store window) and an attractant (the store's internal lighting) that were in existence prior to the installation.

FIG. 1 depicts an already existing storefront staging surface 100, a storefront window, with the store's pre-existing light source 54 visible from the outside. Flying insects 50, mosquitoes in this case, have sensed the store giving off light and gathered at the surface 100.

The embodiment has a vacuum wand 130, a collector assembly 110, a lower track 150 together with a reversible drive motor/helical pinion gear unit 140 and a lower carriage assembly 142. There is a linear helical gear rack 152 affixed inside the lower track 150. The lower track is permanently affixed to exterior wall 52. There is also an upper track 170 that is permanently affixed to exterior wall 52. Upper carriage assembly 160 and lower carriage assembly 142 support and guide the vacuum wand 130, holding it in vertical orientation as it moves along the upper and lower tracks.

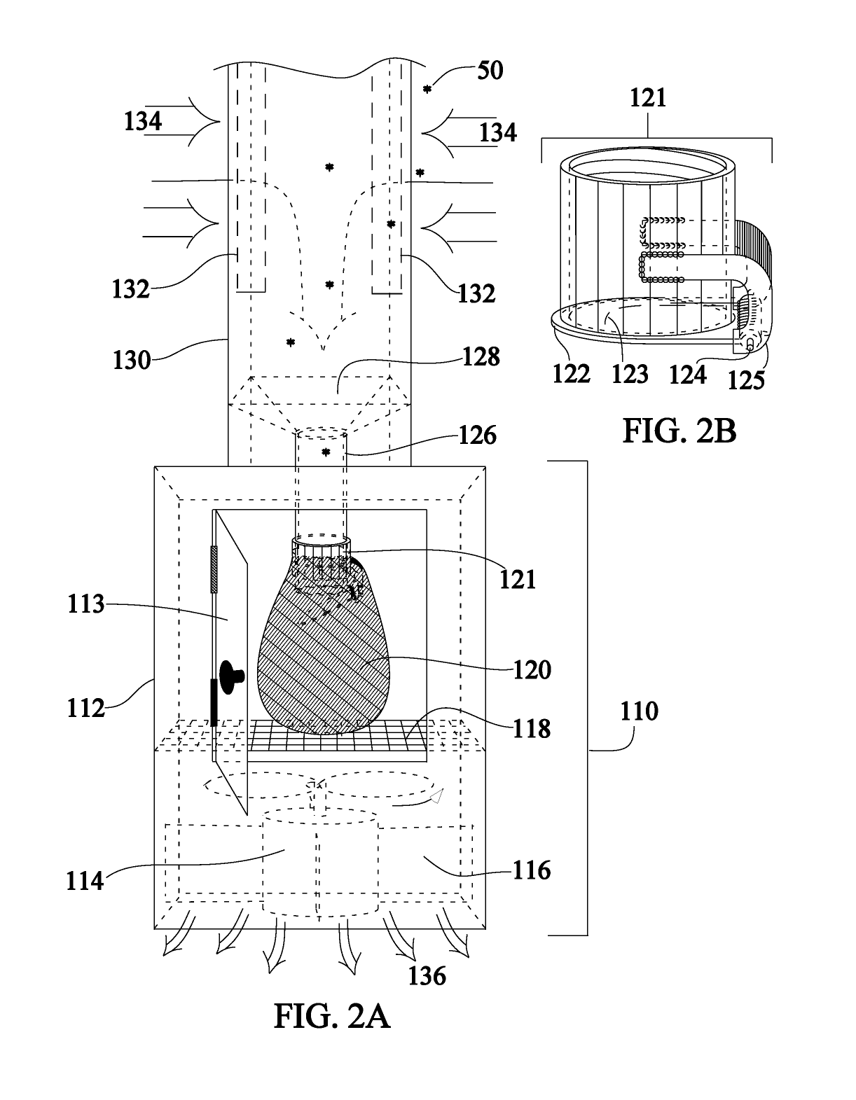

FIG. 2A shows the collector assembly 110 joined to the lower end of the vacuum wand 130. Users gain entry to the assembly through an access door 113. The vacuum wand 130 has air intake slots 132 through which incoming air 134 passes. The incoming air is drawn into the wand by fan motor and blades 114 in the collector assembly 110. As the incoming air 134 enters the wand it brings with it flying insect pests 50 that are gathered at the staging surface 100 as the vacuum wand sweeps over them. The insects are directed downward upon being sucked into the wand and pass through air funnel 128 at the bottom of the wand. The air funnel forms a seal within the wand, being joined to the wand along the wand's internal periphery, which doesn't allow air to leak by.

Funnel tube 126 is joined to the air funnel 128, and passes down into collector assembly housing 112. The funnel tube is threaded at its lower end to receive a collector valve assembly 121, which is mated to collector 120, a mesh bag for holding captured flying insects. The air passes through the collector and then through protective grill 118, which lies between the collector 120 and the fan motor and blades 114, and serves to prevent collector shredding and release of contents should the collector accidentally separate from the valve assembly 121. The outgoing air 136 exits at the bottom of the collector assembly 110. Baffling or other airflow enhancement around the fan motor and blades 114 to channel air passage and increase the fan's efficiency is not shown, though it is contemplated.

FIG. 2B shows the collector valve assembly 121. It is a short tube with internal threads that mate with the external threads on the funnel tube 126 and has a valve frame 125 affixed to it. The valve frame has a valve spring form 124 spanning its two sides. Wrapped around the spring form is a collector valve spring 123, made of spring wire, which has a short extension fastened off to the valve frame 125 for stability. The other end of the spring wire is an extension that reaches under a collector valve flap 122. The valve flap is hinged at the valve spring form 124, and is free to rotate about the axis of the spring form.

During operation the rush of air from the draw of the fan 114 through the funnel tube 126 and into the valve assembly 121 causes the valve flap 122 to open against the resistance of the valve spring 123. This opening action allows inducted insects to be carried by the rush of air through the valve and into the collector 120. The air flow is strong enough to prevent insects from escaping back through the valve.

When the fan 114 shuts off automatically at some point, and the air flow stops, the valve flap 122 returns to its closed position because of the closing force of the spring 123, causing the insects to remain trapped in the collector 120.

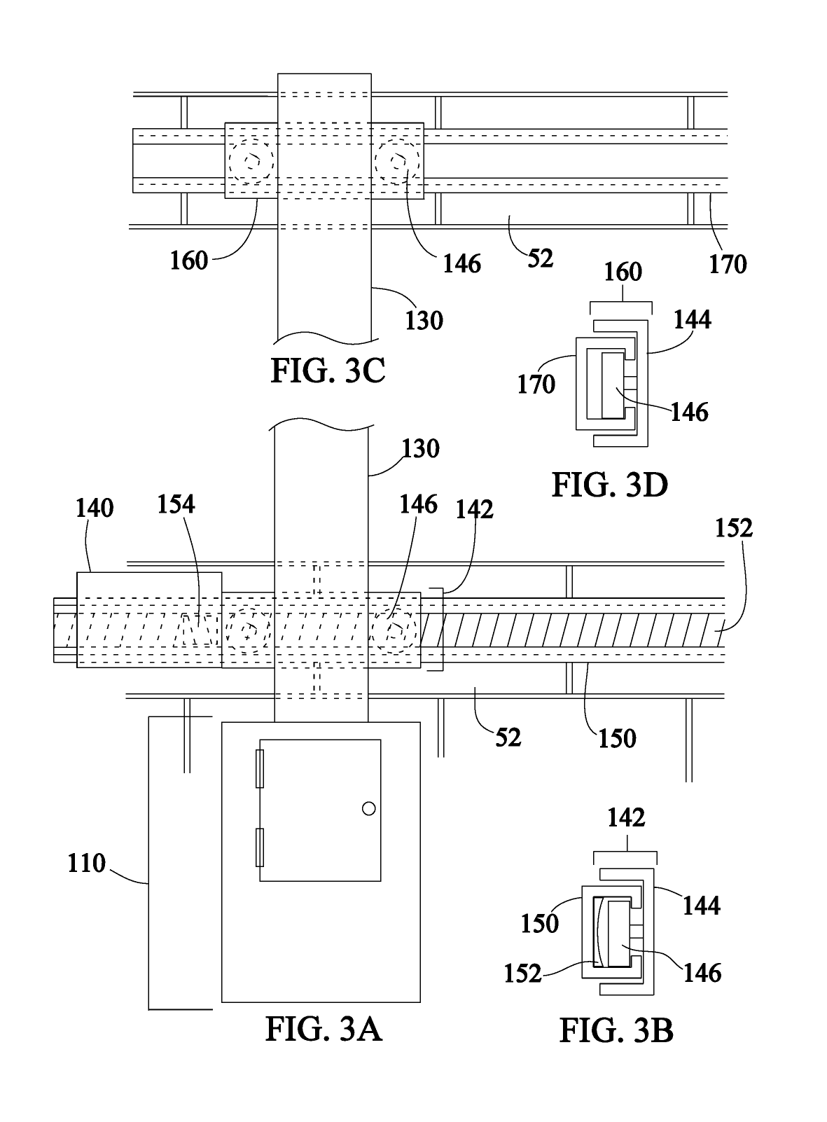

FIG. 3A is a portion of the lower part of the embodiment. Wand 130, with its attached collector assembly 110, is mounted to the lower carriage assembly 142. The lower carriage assembly has one carriage wheel 146 mounted to the carriage front 144 (FIG. 3B), beyond both sides of the vacuum wand. With the fan 114 operating, the reversible drive motor/helical pinion gear unit 140 propels the wand along the lower track 150. To accomplish this, a reversible motor in the drive unit 140 turns helical pinion gear 154, which is engaged with linear helical gear rack 152. As the lower carriage 142 reaches a terminal point near the distal end of the lower track 150 it automatically reverses direction, returning to a beginning point along the lower track. This double swiping of the staging surface 100 by the wand 130 under vacuum serves to remove insects that were not captured in the first pass.

FIG. 3B depicts an end view of the lower carriage assembly 142 in its track 150. Carriage front 144 laps over the lower track 150 and has two carriage wheels 146 affixed to it (one shown) that contact the floor inside the lower track and rotate as the carriage proceeds along the track. Linear helical gear rack 152 is affixed to the inside of the rear wall of the lower track and receives the helical pinion gear 154 that is turned by the drive motor 140 in propelling the carriage.

FIG. 3C illustrates an upper portion of the embodiment. The vacuum wand 130 is mounted to the upper carriage assembly 160, which travels along the upper track 170 on wheels 146 that are affixed to the carriage front 144 as in the lower carriage assembly 142 of FIG. 3B.

FIG. 3D shows the upper track 170 and its upper carriage assembly 160 in end view. The details of this carriage assembly and its track are the same as with the lower carriage assembly 142 and lower track 150 of FIG. 3B, except that there is the linear helical gear rack 152 in the lower track.

### Using the First Embodiment

This embodiment, as with each of the others, operates automatically. This is to say that the motive power and the fan are controlled automatically. They come on at pre-determined timing intervals, the drive motor moving the vacuum system along a direction until a point of reversal is reached. At that pre-determined point, determined either by a positioning device or a timer (neither of which is shown), and with the fan still operating, the vacuum system reverses its positional direction, ending up for that cycle at its beginning location, where the drive motor and fan turn off until the next pre-determined cycle begins. This can happen automatically several times a day if desired.

In using the first embodiment at a store or other pre-existing location with a window, the store's (or other structure's) already existing independent internal lighting is the attractant. Once an electronic timer (not shown) is set that controls the on-off operation of the embodiment up to several times per, there is only one thing for an end user to do: perhaps daily if desired, the user can check to see if the collector 120 . . . which is the mesh bag attached to the collector valve assembly 121 . . . contains enough trapped insects to warrant the user exchanging the existing collector for a new one.

The user installs a new collector 120 as needed by opening the collector assembly access door 113 and unscrewing the collector valve assembly 121 from the threaded funnel tube 126. The collector 120 is affixed to the valve assembly 121, so that the collector and valve assembly are removed as a unit. When a collector is seen to have sufficient insects in it, the valve assembly 121, with its collector 120, is unscrewed from the funnel tube 126 and a new one is installed. The changed out collector unit is then discarded.

A transparent access door could be incorporated, so that checking the collector for fullness would be simpler. An ambient light monitor could be included with the embodiment's design to control operation more closely, especially where daylight saving time may affect the operation or distance from the equator is a factor.

### Operation of the Second Embodiment

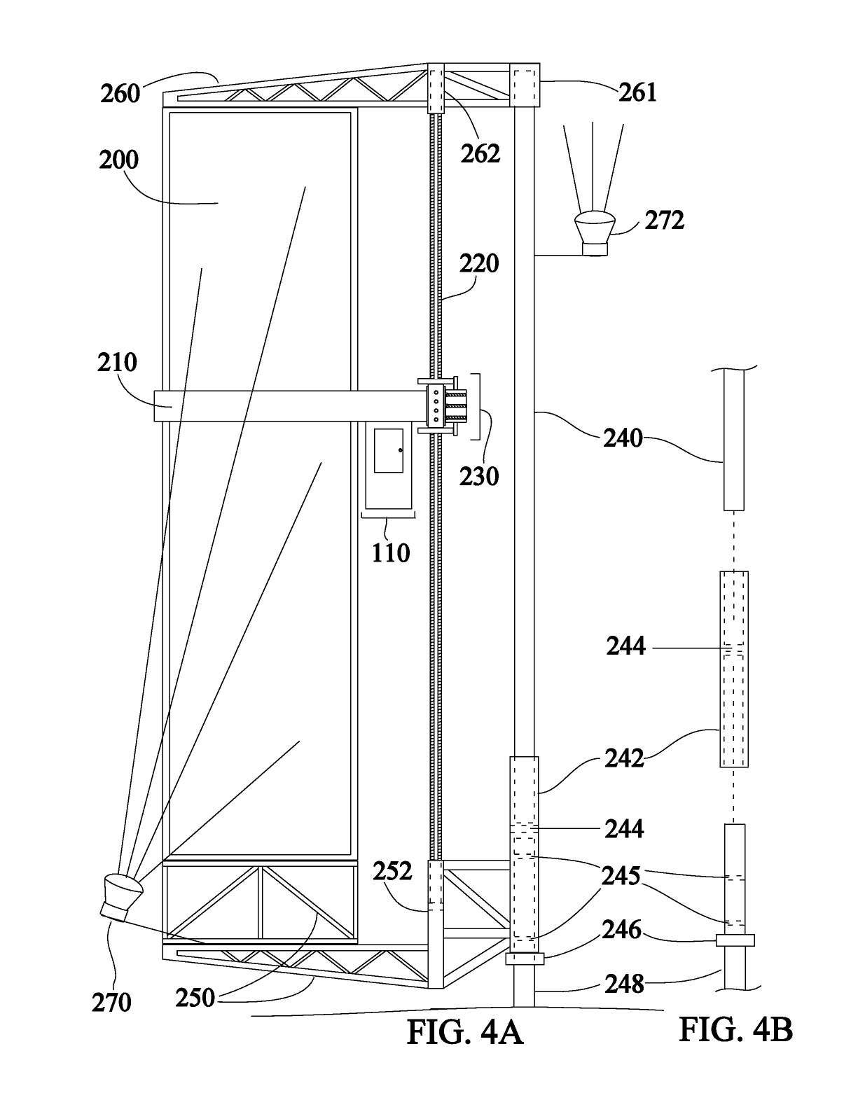

A second embodiment described, FIGS. 4-6, is of a device that is suitable for a large installation, perhaps a soccer stadium, a school or children's playing field. It is envisioned also as having use in a village setting.

FIGS. 4A and 4B show a public venue staging surface 200 oriented vertically. There is also contemplated by the author, but not described here, a horizontally orientated embodiment that works similarly.

Staging surface 200 is held in place by a lower frame 250 and an upper frame 260. These two frames also have a screw shaft 220 running between them. The upper frame is affixed to an upper pole 240 at the upper pole frame support 261, the upper pole being inserted to the upper frame support 261 and affixed in place. The upper pole 240 is secured at its lower end by being inserted to a pole sleeve 242 and seated upon a pole stop 244, which has been affixed to the interior of the pole sleeve 242. The upper pole is affixed to the pole sleeve by welding it in place.

The pole sleeve 242 is placed over a lower pole 248 which is anchored in the ground. The pole sleeve is held in place laterally by sleeve bearings 245 that are affixed within the pole sleeve 242 and allow the pole sleeve's free rotation upon installation of the pole sleeve over the lower pole 248 since the pole sleeve sits upon a freely rotating support bearing 246. The support bearing is affixed to the exterior of the lower pole 248 at a position that prevents the lower pole from contacting the pole stop 244 inside the pole sleeve. The support bearing 246 must be strong enough to carry the weight of the entire embodiment, extra the lower pole, and also allow rotation. Rotation of the embodiment about the axis of the lower pole 248 is necessary because of wind blowing against the staging surface 200. Without the ability to rotate, which lessens the force of the wind against the embodiment, a tall sail will have been created, and that could lead to the embodiment's destruction in a storm.

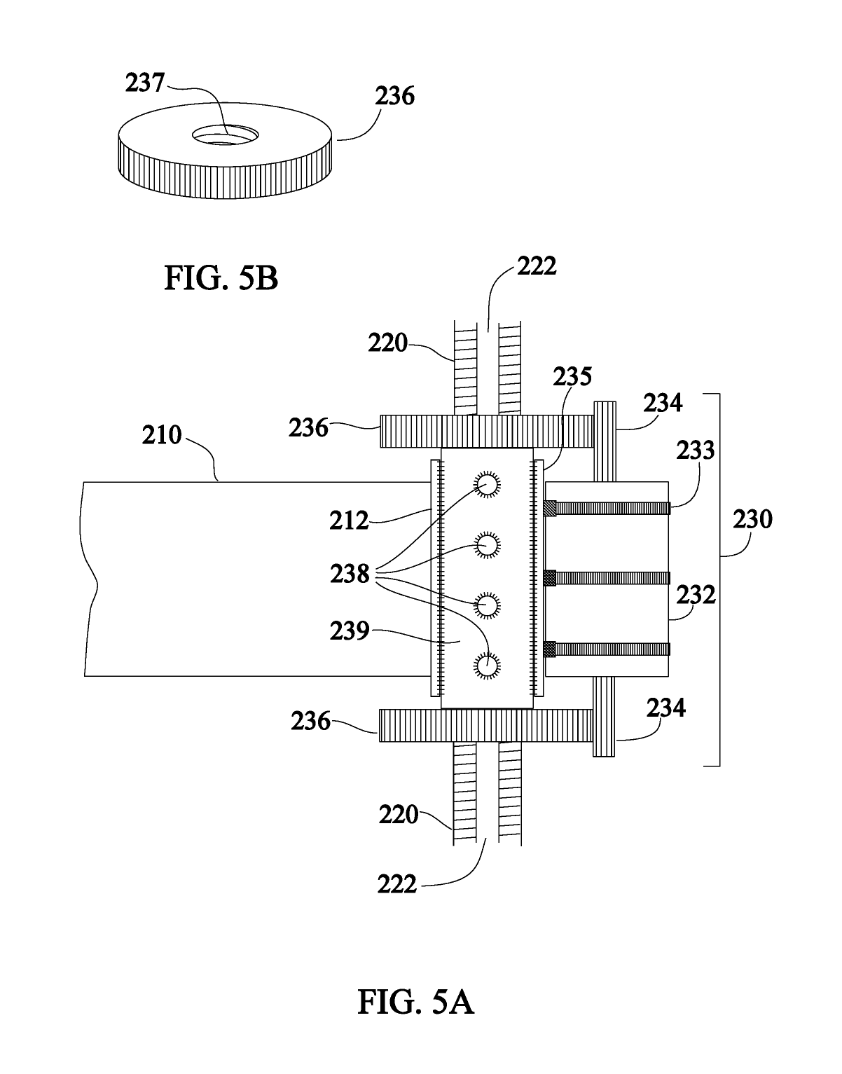

FIG. 4A further displays a bifurcated vacuum wand 210, its wand drive assembly 230 upon screw shaft 220 and a collector assembly 110. These are presented in the following discussion of FIGS. 5A and B, and 6A, B and C. Notice that light 270 is oriented toward the staging surface and light 272 is not. The reason light 272 is pointing up in the air is that a plume of flying insects may form within or around its beams and members of the plume may be attracted to the staging surface, thus undergoing a final disposition. It is also contemplated by the author that a plume that forms can be dealt with by a flexible containment device descending about the plume from above to trap it and bring about further disposition.

FIGS. 5A and B depict the drive mechanism that sweeps the bifurcated vacuum wand 210 over the staging surface 200. The wand is moved by way of a wand drive assembly 230. The wand is affixed to the drive assembly at a wand mounting plate 212, a metal plate that is welded to a sliding collar 239. The sliding collar is a smooth bore tube, the inner diameter of which allows it to travel along the screw shaft 220 without wobbling or binding.

The sliding collar 239 is situated on the screw shaft 220 between two screw shaft gears 236 that have internal threads 237 that mate to external threads on the screw shaft 220. The screw shaft gears sandwich the sliding collar loosely so that the gears can be easily turned while in contact with the sliding collar 239.

A drive motor/gear reduction unit 232 is reversible and engages the two screw shaft gears 236 by way of two splined shafts 234. These shafts, each spinning in the same direction, cause the two screw shaft gears 236 to be turned in the same direction, so that the gears move up and down the screw shaft 220 in unison. Screw shaft keys 238, which are plugs that protrude through the sliding collar 239 and into a milled out zone in the screw shaft key slot 222, are welded into place in the sliding collar 239. The screw shaft keys 238 prevent the sliding collar from beginning to rotate about the screw shaft 220 as the sliding collar travels along the screw shaft.

The drive motor/gear reduction unit is held to a motor mounting plate 235 by motor straps 233 and a cradling system or other appropriate devices. The motor mounting plate is welded to the sliding collar 239.

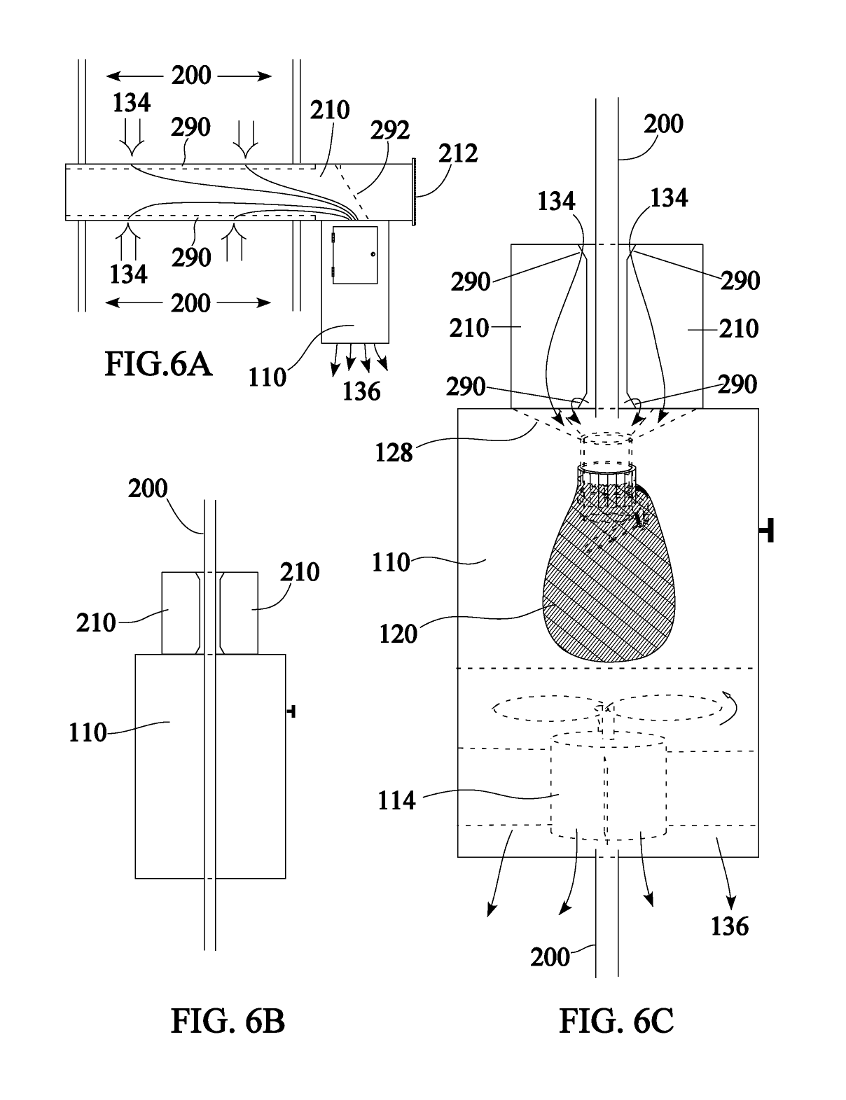

FIGS. 6A, B and C show the vacuum wand 210 in detail. FIG. 6A illustrates the incoming air 134 having entered air intake ports 290, which are located along the edges at the top and bottom of the vacuum wand. Upon entering the wand the air is directed toward the collector assembly 110. There is an interior air channeling wall 292 toward the mounting plate 212 end of the wand, beyond where the air enters the funnel tube 128 in exiting the wand. The wall helps the air and insects to enter the air funnel, and thus the collector, by deflecting air downward.

FIG. 6B demonstrates why the wand 210 is designated as “bifurcated”. The wand 210 is seen in end view, looking from the outboard edge of the embodiment (the left side of FIG. 4A) inward toward the screw shaft 220 and upper pole 240. The wand is cloven, allowing it to pass along both sides of the staging surface 200. In FIG. 6B the end of the vacuum wand that is joined to the wand mounting plate 212 is seen to be behind the staging surface 200, as is the left side of collector assembly 110.

FIG. 6C shows incoming air 134 entering the vacuum wand 210 and proceeding through to enter the collector assembly 110 at the air funnel 128. The four air intake ports 290 along the inboard edges of the bifurcated wand 210 have air 134 passing through them as the wand 210 sweeps the staging surface 200. The staging surface is shown here as discontinuous upper and lower parts of the whole in order to allow a clearer view of the air flow into the funnel 128 and on through the collector 120.

### Using the Second Embodiment

Please see USING THE FIRST EMBODIMENT, with the addendum that in addition to the motive power and vacuum system being able to be set by the user and run automatically, the second embodiment's lighting is also controlled automatically and can be pre-determined by the user as to on-off times as best fit the user's needs.

### Operaton of the Third Embodiment

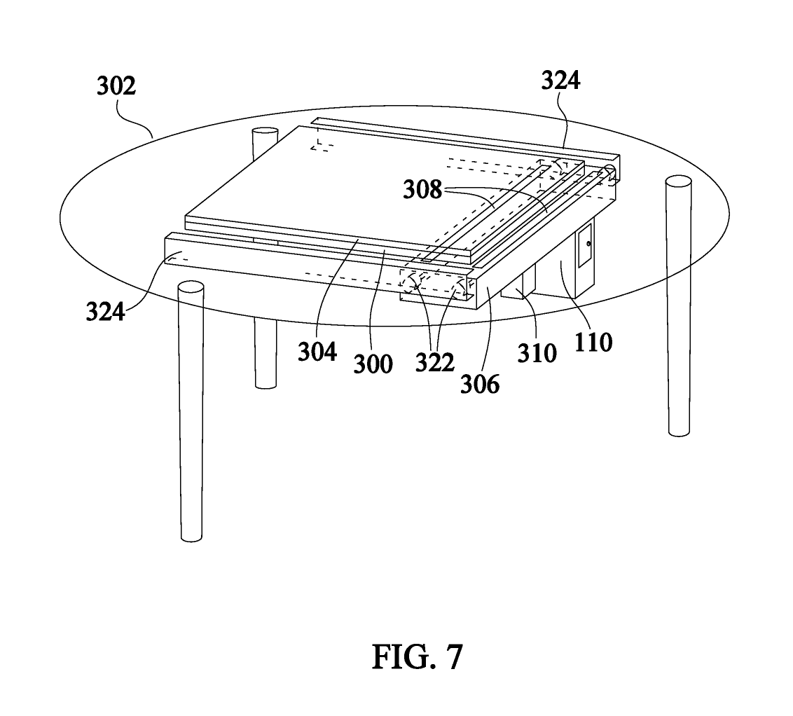

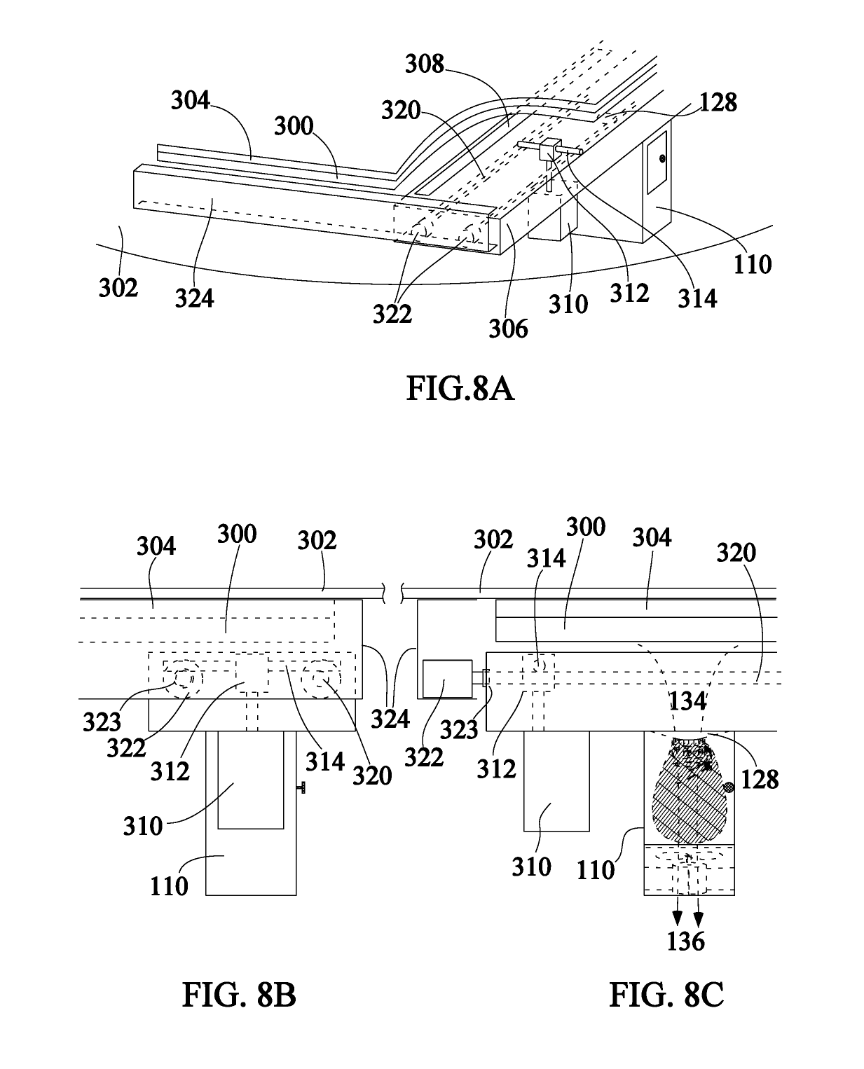

A third embodiment, FIGS. 7-8, is of a smaller device, one that mounts horizontally to a transparent table top and is suitable for the deck or patio at a house. However, it can be re-configured to large scale by grouping a number of the device's flat panel surfaces together in an array, and see duty trapping insects as though a vertically oriented billboard placed out in a field, using the type of vacuum wand from the first embodiment.

FIG. 7 is of a flat panel staging surface. A flat panel display 300, of a type used in entertainment or communication devices, is oriented downward from the underside of a table. In this embodiment the flat panel display 300 is mounted by affixing its back side to the back side of an upward-facing solar panel 304, which is itself mounted to the underside of a table 302 with a transparent top. The solar panel 304 powers the embodiment by way of charging a battery at the table, not shown.

There is a table vacuum carriage 306 that moves along two carriage support channels 324. The support channels are affixed to the underside of the table top 302 and are tall enough to allow the table vacuum carriage 306, which rides on wheels 322, to sweep underneath the flat panel 300. The wheels 322 are driven by a reversible drive motor/gear reduction unit 310. The vacuum carriage 306, has two air intake slots 308 in its top side and it utilizes an attached collector assembly 110 to power the vacuum and hold collected insects.

FIGS. 8A, B and C are more detailed views of the flat panel embodiment of FIG. 7. In FIG. 8A wheels 322 (only two of four are shown) are affixed to axles 320 (one axle is numbered). Motive power is supplied by the drive motor/gear reduction unit 310. The axles are turned by a drive differential 312 and its worm drive shaft 314, which mates to the axles. The flat panel display 300 is seen in FIG. 8A to be joined over its area to the solar panel 304. Also seen is the air funnel 128 (in hidden view), that leads to the collector assembly 110.

FIG. 8B is an end view along the line of the axles 320. Solar panel 304 is joined to the underside of the table top 302 and the flat panel display 300 is joined to the back side of the solar panel. The wheels 322 are riding in a carriage support channel 324 and the worm drive shaft 314 is seen in contact with the axles 320, which pass through axle bearings 323 (one shown in FIGS. 8B and C) in the side walls of the vacuum carriage 306 (FIG. 8A). Worm gearing in the axle is not shown.

FIG. 8C shows the embodiment from along the line of a carriage support channel 324, a view rotated 90 degrees from the line of the axles 320. Incoming air 134 is depicted as passing through the vacuum carriage 306 (FIG. 8A) and the air funnel 128, and out through the bottom of the collector assembly 110 at 136.

### Using the Third Embodiment

Please see USING THE FIRST EMBODIMENT, with the addendum that in addition to the motive power and vacuum system being able to be set by the user and run automatically, the third embodiment's flat panel lighting is also controlled automatically and can be pre-determined by the user as to on-off times as best fit the user's needs.

### Operation of the Fourth Embodiment

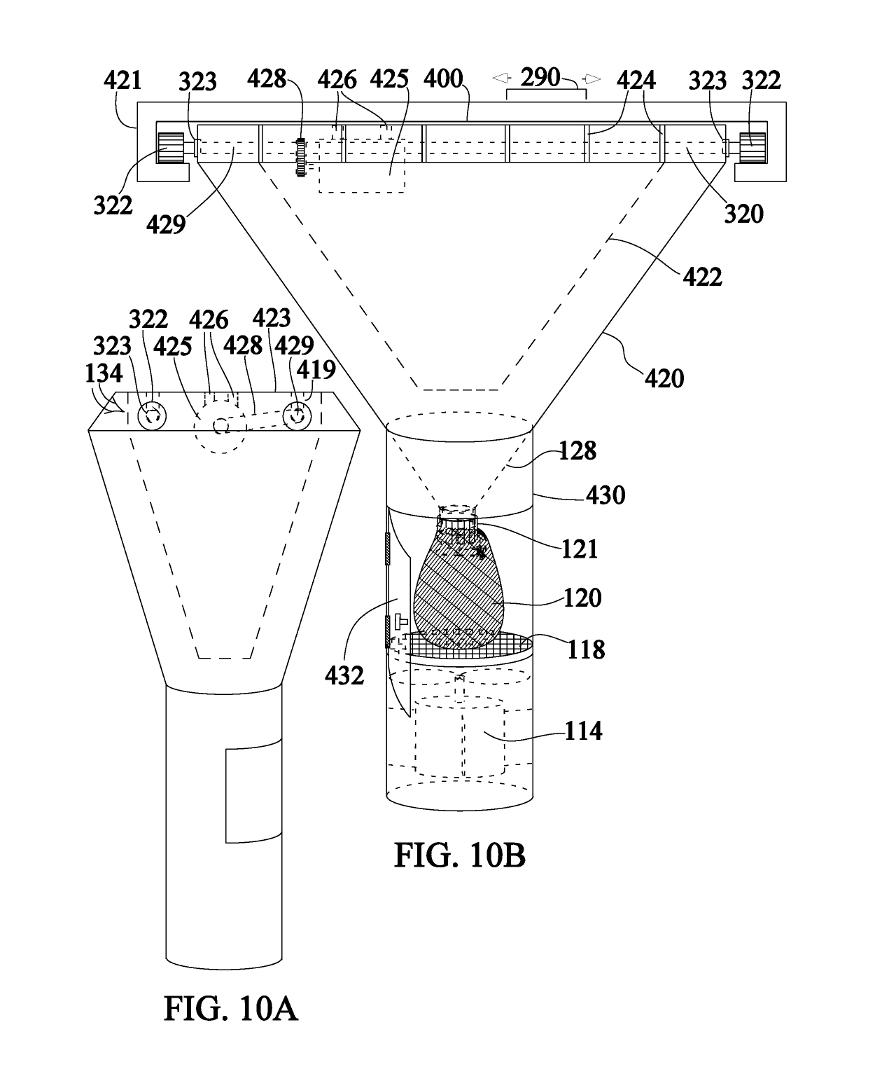

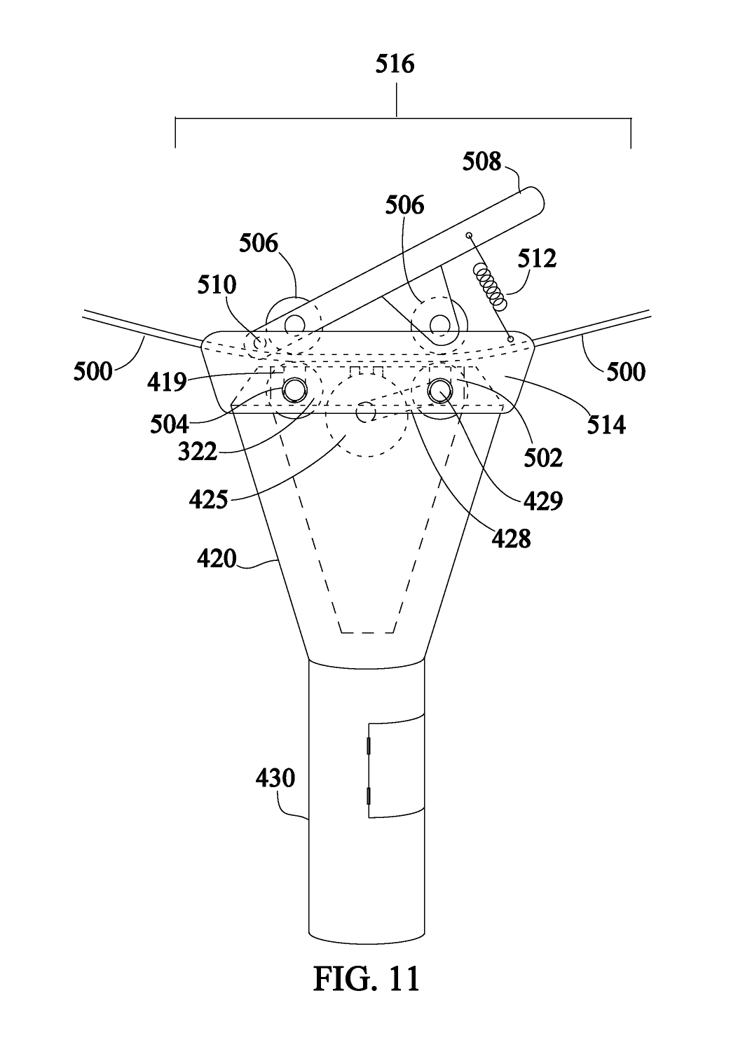

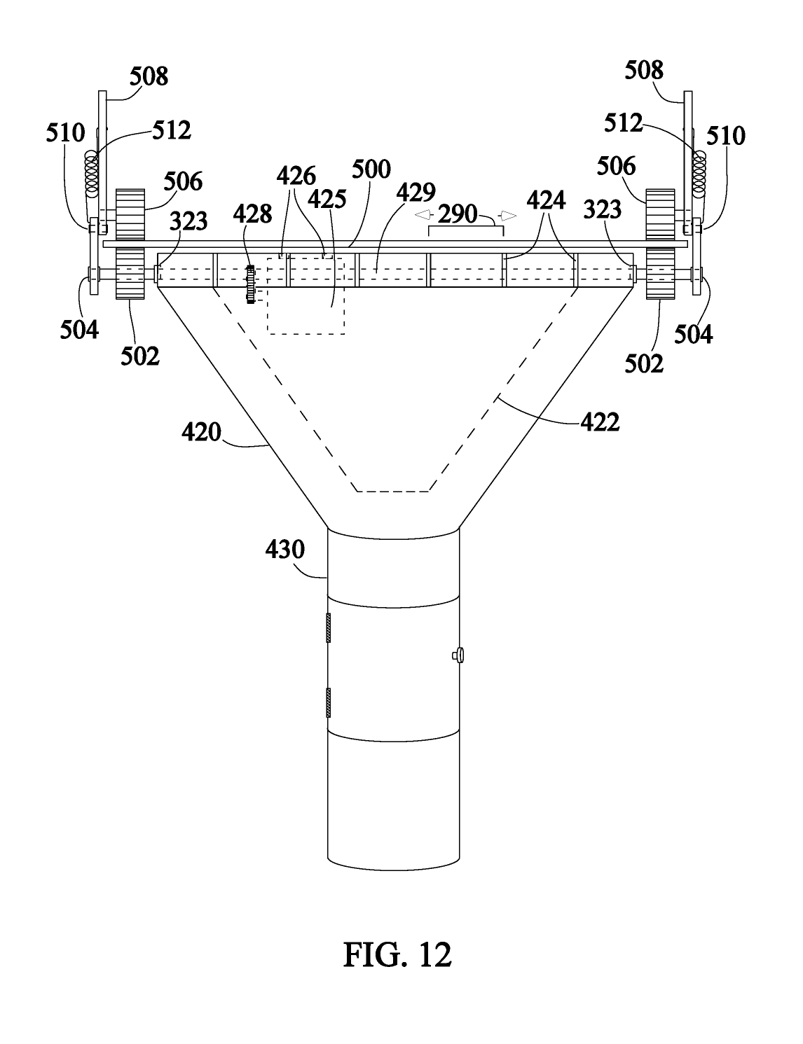

A fourth embodiment, FIGS. 9-10, is shown in a home use configuration. But this embodiment has application at any building that has soffits at the exterior juncture of roof and wall. And beyond soffits, any structure that allows mounting on an underneath portion within flying insect range is a good candidate. And too, the staging surface can be made to be flexible, depending on the materials used. Thus it can overlap with the next embodiment, that of FIGS. 11-12.

FIGS. 9A, B and C are of a soffit staging embodiment. The soffit is that part of a building's roof that overhangs an exterior wall. Typically it is paneled to cover up a view of the roof rafters from below.

Soffit 58 is seen in FIG. 9A to be extending from exterior wall 52 out to meet the roof 56 at the roof's extremity. A soffit staging surface 400 is affixed to the soffit, oriented downward. Non-integral light source 410 is mounted to wall 52. Electrical leads 411 run to the light source and to a soffit vacuum carriage 420.

FIGS. 9B and 9C show flying insects 50 at the underside of the staging surface 400, most of them on the surface, but some are hovering just underneath. Others have been drawn into the device. The current direction of motion of the vacuum carriage 420 is from right to left. The soffit vacuum carriage of FIGS. 9B and 9C incorporates a light source 412 that is integral to the carriage. Light rays are seen to be reflected by the staging surface 400. Incoming air 134 and outgoing air 136 are shown. Wheels 322 (FIGS. 10A and B) are riding on the inside of soffit support channels 421. A soffit collector canister 430, with its canister access door 432, is at the bottom of the vacuum carriage 420.

FIGS. 10A and 10B are respectively an end view and a face view of the soffit vacuum carriage 420. The soffit collector canister 430 is attached at the bottom of the carriage. FIG. 10A shows a reversible drive motor/gear reduction unit 425 mounted to the vacuum carriage top 423 by way of a motor mount 426. A drive belt 428 runs from the drive motor 425 to a driven axle 429. Both axles pass through axle slots 419 in a channeling box 422. The box guides the airflow into the air funnel 128 and protects the motor and drive belt from contamination by insects. The axle slots allow the channeling box, which is open-topped, to be slid over the axles and affixed to the vacuum carriage top 423 after the motor and drive belt are installed to the carriage top. The axles pass through axle bearings 323 (one shown in FIG. 10A) in the side walls of the vacuum carriage's top 423. Incoming air is shown at 134, passing through air intake ports 290 (FIG. 10B) in the top of the vacuum carriage.

FIG. 10B shows the vacuum carriage 420 installed to the carriage support channels 421, which are integral to the soffit staging surface 400. Wheels 322 are riding in the support channels 421. The drive belt 428 is shown connecting the drive motor 425 to the driven axle 429. There is air intake bridging 424 extending across the air intake ports 290 that gives strength to the relationship between the vacuum carriage top 423 and the body of the vacuum carriage 420. The air intake port 290 shown in FIG. 10B is a segment of one long port extending across the width of the vacuum carriage. The single port at this near side is interrupted by spaced apart air intake bridging 424.

Soffit collector canister 430 houses collector 120 and its integral collector valve assembly 121. Protective grill 118 is installed to make sure that the collector and fingers stay out of the area of the fan motor and blades 114. The collector and valve assembly are installed by user entry through canister access door 432.

### Using the Fourth Embodiment

Please see USING THE FIRST EMBODIMENT, with the addenda that in this fourth embodiment a soffit collector canister 430 and its canister access door 432 have replaced the collector assembly 110 and the access door 113 of the first embodiment. And the present embodiment's attractant lighting, as with each embodiment—second through sixth—is controlled automatically at the user's discretion.

### Operation of the Fifth Embodiment

A fifth embodiment, FIGS. 11-12, utilizes a flexible staging surface in sheet form. This is suitable over a wide range of applications, from backyard use as a hammock-like device, up to large scale use as a protective ring around a village, where a plurality have been connected together.

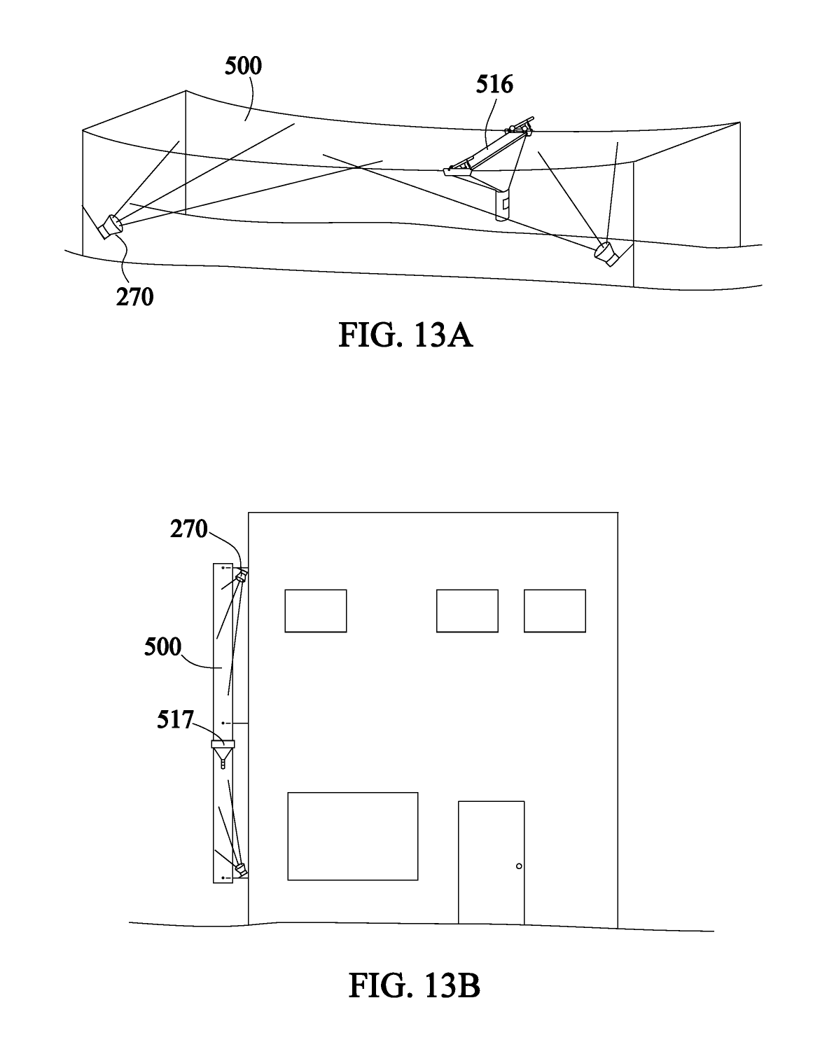

FIG. 11 is of a flexible staging surface assembly 516. Although the soffit staging surface 400 and carriage support channels 421 of FIGS. 9 and 10 can easily me made flexible, the flexible staging surface of FIGS. 11, 12 and 13 has the advantage of being less expensive to produce per linear foot. The embodiment involves a sheet of material, flexible staging surface 500, strong enough to hold a vacuum device's weight. The surface is a light-reflective sheet that passes between two sets of wheels at each end of a soffit vacuum carriage 420, two wheels on top of the staging surface and two wheels on the underside. A driven axle 429 provides motive power to the embodiment, being turned by a reversible drive motor 425 acting through a drive belt 428. The driven axle 429 is beneath the staging surface 500 and is joined to a traction wheel 502 at each end of the axle (only one shown in this view). Another wheel 322 is also beneath the staging surface. It isn't driven, but is contemplated to easily be. Side plate axle bearings 504 (one shown) are used in a side plate 514 at each side of the vacuum carriage 420 (see FIG. 12).

On top of the flexible surface 500 are clamping wheels 506. These are free to rotate and are affixed to a clamping lever 508 that pivots on a clamping lever pivot 510, which is a pin through a hole in the side plate 514 that allows the clamping lever to be raised and lowered. Each clamping wheel 506 is positioned directly above the wheel beneath it when in operation to provide proper stability and compressive force. A clamping lever spring 512 provides the force necessary for good contact at the four wheels.

FIG. 12 shows the soffit vacuum carriage 420 in face view, mounted to the flexible staging surface 500. The staging surface is shown as though terminating at the four wheels shown, but the staging surface should be recognized as extending in both directions, into the page and out toward the viewer.

As mentioned, the clamping wheels 506 squeeze down upon traction wheels 502 by way of the force provided by the clamping lever spring 512 acting upon the clamping lever 508. The lever, which has a fit to the clamping lever pivot 510 that allows for rotation of the lever, is lifted during the placement of the assembly 516 on the flexible staging surface 500. If the staging surface is laterally stiff, then the assembly can be placed on it at an end of the staging surface that has been temporarily disconnected from a supporting device.

### Using the Fifth Embodiment

Please see USING THE FIRST EMBODIMENT, with the addenda that here in this fifth embodiment the same soffit collector canister 430 as with the fourth embodiment, and its canister access door 432 (not numbered on drawings 11 and 12), have replaced the collector assembly 110 and the access door 113 of the first embodiment, and the present embodiment's attractant lighting is controlled automatically, as with the second through sixth embodiment.

### Operation of the Sixth Embodiment

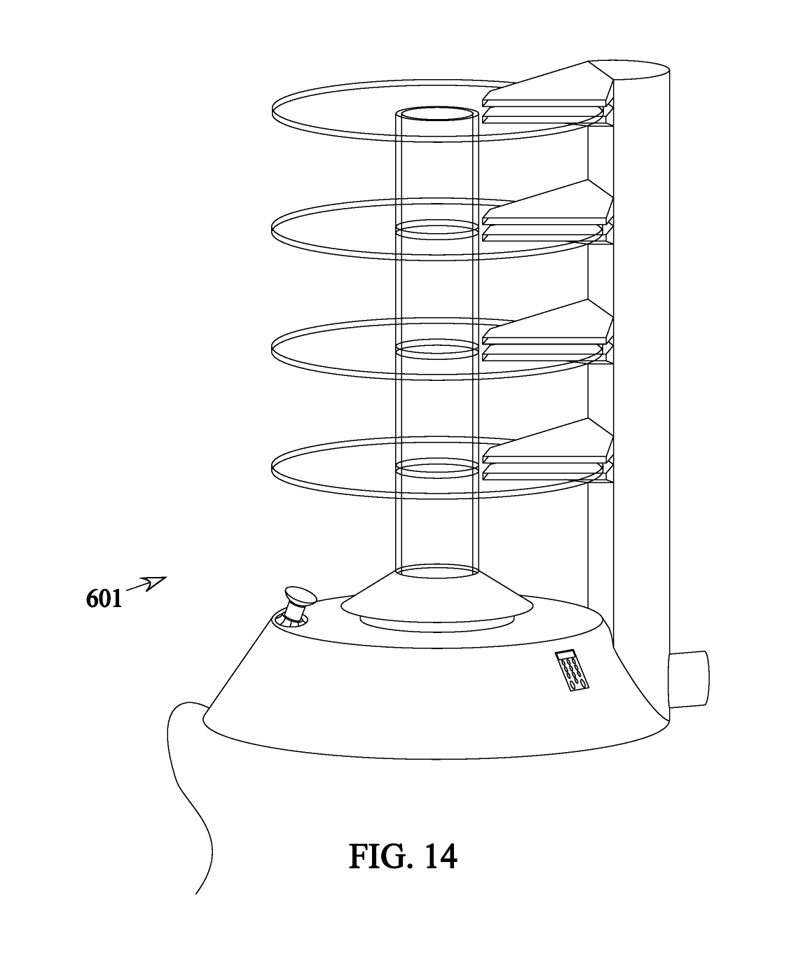

A sixth embodiment, FIGS. 14-17, is seen as having use in a family's yard or deck setting. It can also be designed to be taken on outings and powered by a car's electrical system or by solar cells. And it can be scaled to larger size and used inside supermarkets and other buildings.

FIG. 14 is an external view of a transparent rotatable staging surface assembly 601. This embodiment is contemplated for use by families outside on the deck or in the yard. A larger derivative of it could be used in supermarkets or other buildings, and a smaller device could be used at picnics or other outings, being plugged into a car's electrical system. Or it could carry its own battery, charged by a solar panel.

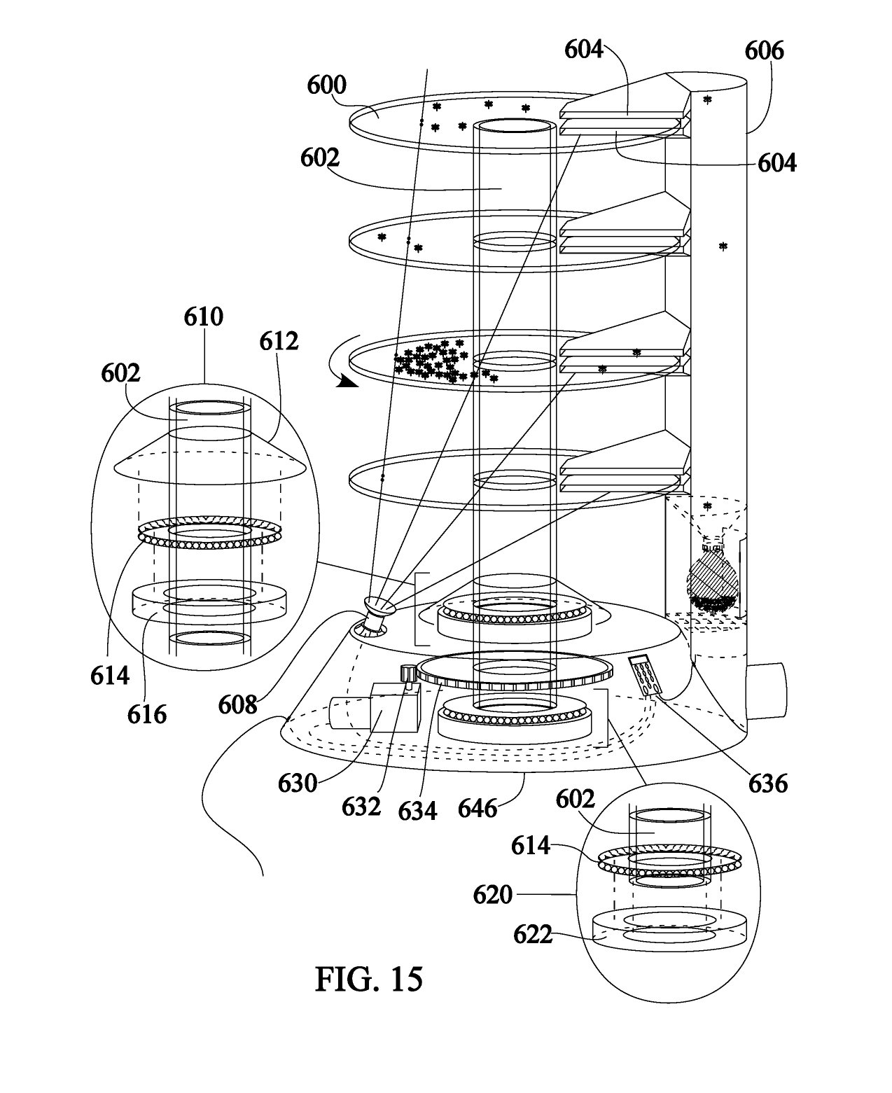

FIG. 15 has the embodiment in more detail. A transparent rotatable staging surface 600, in the shape of a circular platen, is affixed at the top of a transparent support column 602. Several other transparent platens are likewise affixed at lower depths along the column, holes having been placed at the centers of these platens to allow installation on the column. The support column 602 enters a base 646 at a hole (not shown) in the middle of the base's upper level and goes through to the floor.

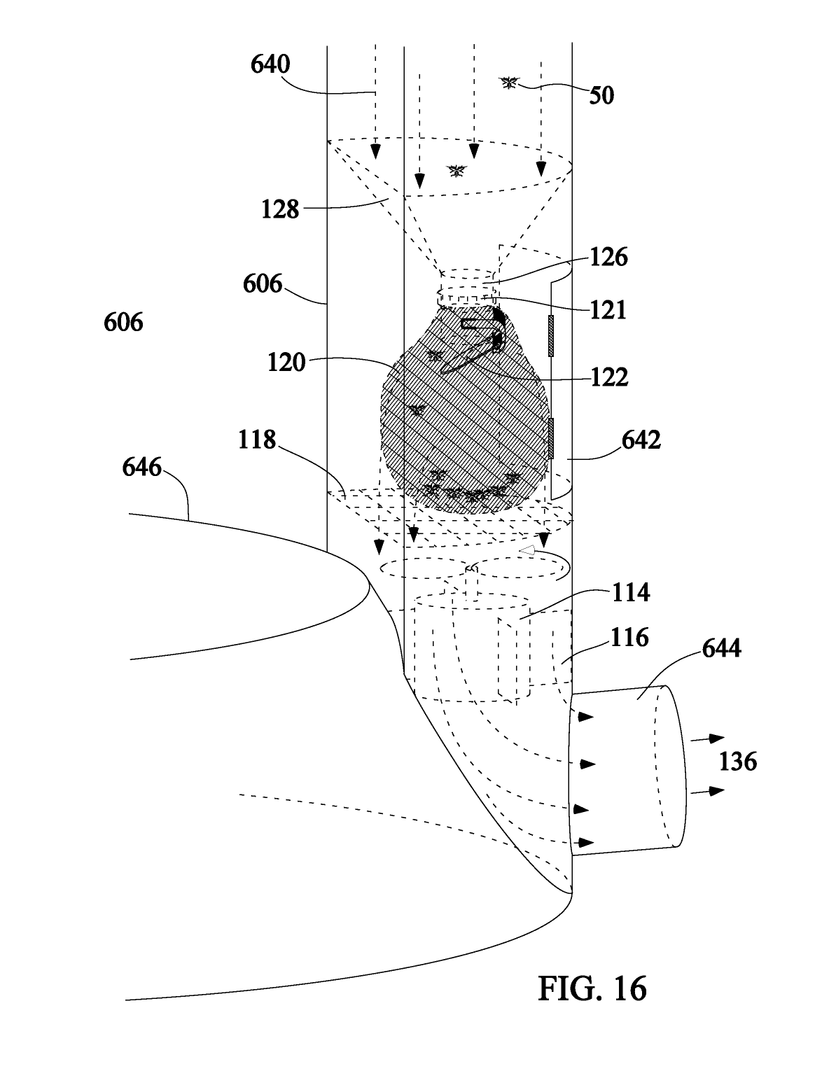

Vacuum inlets 604 are placed on either side of the various staging surfaces, top and bottom, and open into a vacuum tube 606 that confines air flow 640 (FIG. 16) as it is drawn down the vacuum tube by a fan motor and blades 114 (FIG. 16). An integral light source 608 attracts flying insects to the embodiment, where they gather in number.

A drive motor/gear reduction unit 630 turns a drive gear 632 that is mated to a driven gear 634. The driven gear is affixed to the support column 602 by way of a hole in the gear's center.

At the left of the drawing assembly 610 shows one of two identical bearings, an upper ball bearing 614 used to hold the transparent support column 602 in place. The upper bearing is affixed to an upper mounting plate 616. The upper plate is affixed to the top of the base 646. There is a protective cover 612 affixed to support column 602 that seals the bearing area from contaminants from above. The cover skirts the top of the bearing and extends down to very close to the top of the base, keeping insects from getting underneath.

The other bearing, the lower ball bearing 614 of assembly 620 at the bottom-right of FIG. 15, is affixed to a lower mounting plate 622. The lower mounting plate is affixed to the floor of the base 646. The support column 602 runs through the lower ball bearing and part of the way through the hole in the lower mounting plate 622, not coming into contact with the floor of the base.

There is an electronic controller 636 that sets the times for the embodiment to operate and recognizes the ambient light level for control purposes. Associated electrical wiring is displayed.

FIG. 16 shows the interior of the vacuum tube 606 in greater detail. The vacuum tube is joined to the base 646. Air flow 640 carries flying insects 50 that are removed from the staging surfaces 600 into the air funnel 128, the construction of which seals the interior of the tube, preventing downward flowing air from going past the funnel.

A collector 120 and its integral collector valve assembly 121 are removably attached to a funnel tube 126 at the base of the air funnel 128. A collector valve flap 122 is shown in the opened position, caused by the air flow drawn by the fan 114. Captured insects are brought through the valve assembly and into the collector as the air flow draws them. The insects are kept from going back up through the valve assembly by the incoming air flow. Once the fan stops the valve flap closes, sealing the insects in the collector.

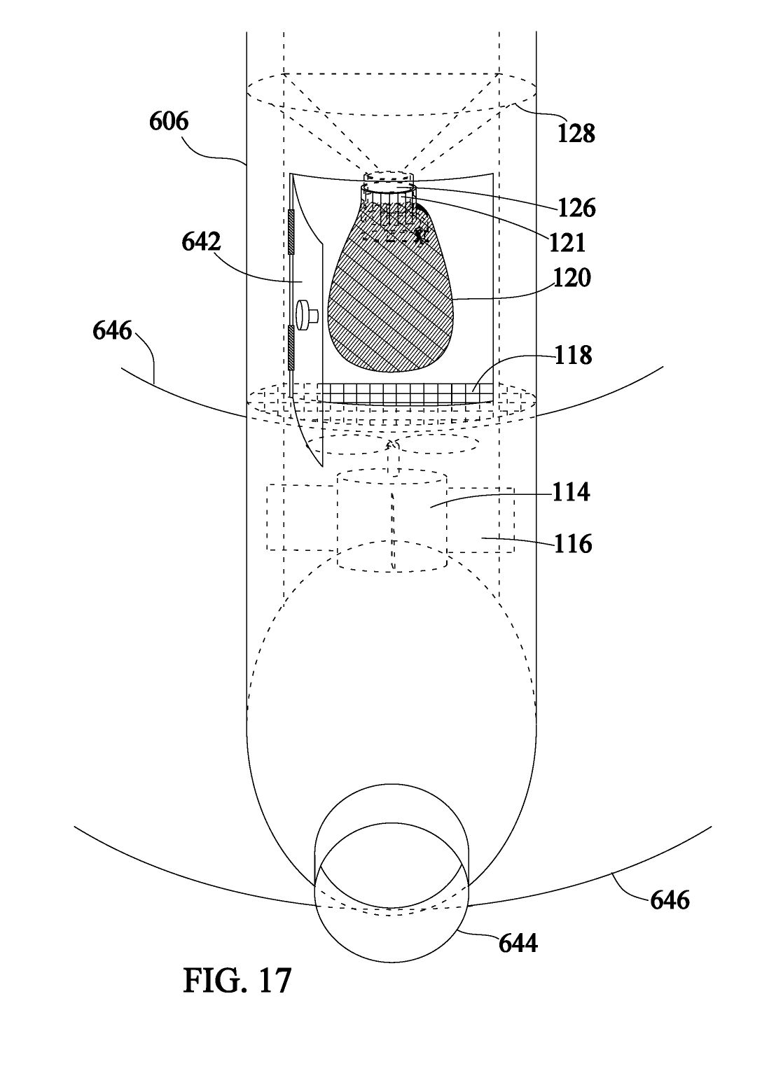

A protective grill 118, which is below the level of the vacuum tube access door 642 (FIG. 17), prevents the collector from being ruptured by the fan 114 in case the collector were to come loose from the collector valve assembly 121. The grill also serves to keep fingers from coming into contact with the fan.

The fan 114 is mounted in the vacuum tube 606 by way of fan support vanes 116 that are affixed to the interior of the tube. Outgoing air exits through an exhaust tube 644.

FIG. 17 is a front view of the vacuum tube 606. The fan 114 is not running and the access door 642 is open for entry to the inside. A new collector 120, with its valve assembly 121, have just been installed at the funnel tube 126. The valve assembly is in the closed position.

### Using the Sixth Embodiment

Please see USING THE FIRST EMBODIMENT, with the addenda that here a vacuum tube 606 and its vacuum tube access door 642 have replaced the collector assembly 110 and the access door 113 of the first embodiment, and this sixth embodiment's attractant lighting, as with each embodiment—second through sixth—is controlled automatically. It is set to come on and shut off at the user's discretion, as is the case also with the embodiment's rotation and vacuum.

### ADVANTAGES

The advantages of the present embodiments over the prior art have been explored in what has been written above. Not delving back into those per se, it seems good to mention the advantages broadly here. In doing that I'll say that the advantages fall into two categories: Health and Comfort.

As mentioned in the section DISCUSSING PRIOR ART GENERALLY and also the section BACKGROUND OF THE INVENTION—OBJECTS AND ADVANTAGES, mosquitoes cause an awful lot of death and misery around the world. If malaria doesn't kill the people afflicted, or make them blind, it at the least is the gift that keeps on giving. Recurrences are for life. And then there are dengue fever, Chikungunya, encephalitis, West Nile and now Zika. It's as though there are six horsemen of the apocalypse.

If a few devices of the present embodiments were stationed around and in villages, near water, and powered by solar cells charging batteries, and in the aggregate 1,000,000 mosquitoes or more were eliminated per 24 hour period, it wouldn't be long before the rates of disease in those locales would fall. That is one great advantage provided by these embodiments over the prior art. The large scale control of mosquito populations is certainly more feasible this way than with devices that attack the problem one mosquito at a time.

When I was in Vietnam everyone in the bush had a bottle of mosquito repellant containing DEET stuck in an elastic band around his helmet. It was either use the stuff or get taken prisoner by the mosquitoes. One advantage with the present embodiments is that now over time, as those pesky little disease and discomfort vectors are killed en masse, less poison will be needed to be applied to your skin to be absorbed. And too, less spraying of toxins should occur. That too is a long term advantage of the present embodiments.

And as to comfort: Mosquitoes damage an awful lot of picnics, outings, golf and soccer games, and more around the world, including sleep. They disrupt group gatherings of friends who want to sit around in the outdoors, peacefully enjoying themselves. And yard work? Forget it when the mosquitoes are out in force. The present embodiments can greatly help with these problems.

### CONCLUSION, RAMIFICATIONS and SCOPE

Thus the reader will see that at least one of the staging surface embodiments provides a more effective, scalable and economical device than what is known in the prior art. The reader will also see that one or more of the embodiments are safer to use and store, because of not using a combustible fuel, and that they are more environmentally friendly, not needing to produce carbon dioxide to operate. Too, the reader will see that by not leaving the remains of insects on any part of the embodiments as a burned, messy, electrocuted residue that serves as an incubator for germs until manually cleaned off, the embodiments produce a healthier, more germ-free environment local to the user.

While my above descriptions contain many specifics, these should not be construed as limitations on the scope, but rather as exemplification of several embodiments thereof. Other variations are possible. For example, the concept of “staging surface” can be broadened to that of a “staging zone”.

In this the freedom of movement of flying insects has been expanded. Insects would be free to fly in any direction within a volume of “staging space”. There may or may not be a surface designed as an element for them to be attracted to. For instance, they could be attracted and gather in the air, under the influence of a light shining in any direction, even downwardly. And when so gathered in a localized fashion, perhaps forming a plume or simply a swarm in the air, they could be confined by a mesh or membranous device that is either lowered or raised or otherwise placed about them as they fly, trapping them for further disposition. If you can attract them you can terminate them.

A further example of a staging zone embodiment is the use of an illuminating or illuminated pole to form a nuclei for insect plumes. A tall pole could contain lights along or within it, or have light shined upon it, to attract insects. The attracted insects could fly around within the proximity of the lighted pole, even above it. At an appropriate time a mesh or membranous device could be either dropped or raised about the insects, trapping them for further disposition.

Of course, light doesn't need to be the sole attractant for any of the embodiments. As given in the claims and prior art, other things work. Blood meal simulants, pheromones, acoustical waves, heat, even radio frequency or microwave energy . . . coherent or non-coherent . . . is contemplated as useful with any of the embodiments, even those of this concluding section.

As to the mechanisms used to eliminate, vacuum devices don't have to be employed. A group of insects can be incapacitated or terminated while voluntarily gathered at a surface or a zone in various ways which are contemplated by the present author. Though not as good for the environment as removing insects by vacuuming them, insects can be sprayed with toxic substances, such as the natural Bt toxin or an engineered analogue or derivative. There are also common yard sprays by companies such as Cutter and Spectracide that will cause death to flying insects, though perhaps not immediately. Sprays can be applied by automatic devices designed in conjunction with the staging surfaces or the 3-dimensional zones of the present embodiments, or their vacuum systems.

Another mechanism contemplated is acoustical overpressure, where sonic pressure waves impinge upon the insects, similar to the subjecting of kidney stones to fragmentation by a sonic resonator, though the insects, being made of soft tissue, wouldn't fragment per se, but they might be biologically damaged in other severe ways. A resonator or transponder, along with an engineered power source, could replace a vacuum system or work in conjunction with it. If the staging surface were largely reflective as far as the acoustical waves to be used, then the acoustical energy would have a greater effect on the insects. Using this application in 3-space, without the reflective boundary of a staging surface may still work.

And heating by microwave energy, either while insects are staging on or near a surface, or are flying in open air (3-space) would be very damaging to them. Also included in this is the use of laser beams. A laser wouldn't need to track an individual insect. That can be expensive. A laser of the appropriate wavelength could automatically scan an entire staging surface periodically, for instance by being aimed along the length of a staging surface, its beam skimming the length within a few millimeters of the surface, and then its beam being caused to sweep the surface, mowing down the insects in its path. A laser could also be moved along a longitudinal track spaced apart from the staging surface, scanning its destructive energy back and forth as the laser traverses the length of the surface.

I claim:

1. In combination: A surface, either rigid or flexible, upon or proximal to which a plurality of insect pests are attracted and able to stage, gathering at or near said surface for a predetermined period of time and means to attract and then after said predetermined period of time remove, physically degrade, biologically alter or genetically modify said insects either automatically or with human initiation.

2. An apparatus for the removal and disposition of, or the in-place degradation or modification of insect pests comprising: An element, element 1, which is a surface portion of a pre-existing construct or else is a surface portion of a construct manufactured for the present invention, upon which said insect pests can gather or hover near to within a few body lengths distance from in unmolested, unhindered fashion for a duration of time, said duration of time enabling an increasing accumulation upon said surface portion of said insects, said apparatus further comprising an element 2, which is a system that after said duration of time, automatically or with human initiation, causes or enhances the departure or removal to a further disposition the said gathered or hovering insects, or else causes their physical or biologic degradation or genetic modification.

3. The apparatus of claim 2 wherein during said duration of time electromagnetic radiation is either reflected by a portion of said surface, transmitted through both a portion of said construct and a portion of its said surface, absorbed by either a portion of said construct's interior or its surface and then emitted at a portion of said construct's surface, with said reflected, transmitted or emitted radiation being of wavelength, duration, timing sequence, intensity or having the ability to create perceived movement, so as to attract said insects to said surface.

4. The apparatus of claim 2 further comprising an element, element 3, producing an electromagnetic radiation that is either oriented in a direction substantially away from said surface, or is reflected by a portion of said surface, transmitted through both a portion of said construct and a portion of its said surface, generated at a portion of said construct's interior or its surface and then emitted at a portion of said construct's surface, absorbed by a portion of said construct's interior or its surface and then emitted at a portion of said construct's surface, said radiation being of wavelength, duration, timing sequence, intensity or having the ability to create perceived movement, so as to attract said insects to said surface.

5. The apparatus of claim 2 wherein said surface portion is of a structure or system of electric or electronic design that produces energy of visual or ultra-violet wavelength, with said visual or ultra-violet wavelength being generated by at least one member selected from the group of technologies consisting of incandescent, fluorescent, phosphorescent, coherent wavelength, liquid crystal display, plasma display, light emitting diodes, organic light emitting diodes, other visual or ultra-violet wavelength technologies, said structure or system being controlled by appropriate devices.

6. The apparatus of claim 2 further comprising an element, element 4, which is a speaker or other kind of electro-mechanical transponder in communication with said apparatus, and that when controlled by appropriate circuitry, causes mechanical vibrations to be induced within or upon said apparatus in order to produce an acoustic radiation discernable at a distance by said insects and to attract them.

7. The apparatus of claim 2 further comprising an element, element 5, which is a speaker or other kind of electro-mechanical device that is operatively near said apparatus, and that when controlled by appropriate circuitry, produces an acoustic energy imparted to the air, wherein said insects are further attracted to said surface from a distance.

8. The apparatus of claim 2 wherein insects, including mosquitoes, are attracted to said surface by utilizing in the proximity of said apparatus the propagation of either heat or water vapor or certain substances found in breath exhalation, perspiration or plant life, with at least one of said substances to be chosen from the group consisting of carbon dioxide, octanol, nonanal, sulcatone, goldenrod, milkweed, other chemical attractants, other biological attractants.

9. The apparatus of claim 2 wherein said insects are either automatically or with human initiation relocated by force or else relocate themselves from upon or hovering near said surface by way of a device or system that causes or enhances transport or departure of said insects to at least one further disposition selected from the group consisting of starvation, electric shock, negative air pressure, oxygen deprivation, air over-pressure, immersion in a fluid, severe overheating, dehydration, dismemberment, excessive physical contact pressure, biologically degrading electromagnetism, biologically degrading acoustic radiation, toxic substance, mobility limiting substance, genetic modification, other biologic modification.

10. The apparatus of claim 2 wherein said insects are either automatically or with human initiation, biologically degraded, genetically modified or terminated while at or near to said surface by way of a device or system that causes at least one disposition selected from the group consisting of starvation, electric shock, negative air pressure, oxygen deprivation, air over-pressure, immersion in a fluid, severe overheating, dehydration, dismemberment, excessive physical contact pressure, destructive electromagnetic radiation, destructive acoustic radiation, toxic substance, mobility limiting substance, genetic modification, other biologic modification.

11. The apparatus of claim 2 wherein a container is used to hold said removed, degraded or terminated insects for later disposition, or else to serve as a confinement vessel during the time said insects are being terminated, said container and contents then to be disposed of.

12. A method for eliminating or modifying insect pests comprising:
(a) providing or utilizing a surface for said insects to be attracted to, so that a plurality of said insects either congregate directly upon or remain within several body lengths distance from said surface over a period of time, during which time period insects within the general vicinity are encouraged to increase the numbers gathered to said surface through a continuing attraction of new arrivals while the insects already gathered to said surface are left alone, remaining unhindered and unmolested and retaining their physical abilities,
(b) attracting said insects to said surface by way of at least one of the effects or attractants selected from the group consisting of the emission, the transmission, the reflection, the absorption/re-emission of electromagnetic energy, acoustic vibration, water vapor, carbon dioxide, pheromones, octanol, nonanal, sulcatone, goldenrod, milkweed, other chemical attractants, other biological attractants,
(c) providing at or near said surface, either automatically or with human initiation, the loss of freedom of movement of said insects or their physical degradation, by way of the application of at least one cause of said loss or freedom or degradation selected from the group consisting of being removed by vacuum and transported for further disposition, starvation, oxygen deprivation, dehydration, severe overheating, air under-pressure, air over-pressure, immersion in a fluid, excess physical contact pressure, mobility limiting substance, toxic substance, destructive acoustic radiation, electric shock, dismemberment, coherent energy beam, destructive electromagnetic radiation, biochemical modification, genetic modification,
(d) providing for the final disposition of said insects by way of at least one member selected from the group consisting of sequestering biologically viable, biologically degraded or terminated insects in a throwaway container until an appropriate time, sequestering said insects in a burnable container for complete destruction, sequestering said insects in a container or confining volume that enters into communication with a substance or effect that causes said insects' ultimate termination or destruction, causing any remains of said terminated or degraded insects to enter the outside natural environment to be ultimately disposed, causing biochemically or genetically modified mosquitoes to enter the outside natural environment,
whereby said insect pests are efficiently eliminated or modified in large numbers.
